(19) United States
(12) Patent Application Publication
(10) Pub. No.: US 2004/0138933 A1
(43) Pub. Date: Jul. 15, 2004

(54) Development of a model for integration into a business intelligence system

(76) Inventors: Christina A. LaComb, Cropseyville, NY (US); Amy V. Aragones, Clifton Park, NY (US); Hong Cheng, Niskayuna, NY (US); Michael C. Clark, Glen Ellyn, IL (US); Snehil Gambhir, Niskayuna, NY (US); Mark R. Gilder, Clifton Park, NY (US); John A. Interrante, Schenectady, NY (US); Christopher D. Johnson, Clifton Park, NY (US); Thomas P. Repoff, Sprakers, NY (US); Deniz Senturk, Schenectady, NY (US)

Correspondence Address: LEE & HAYES PLLC, SUITE 500, 421 W RIVERSIDE, SPOKANE, WA, 99201

(21) Appl. No.: 10/418,428

(22) Filed: Apr. 18, 2003

Related U.S. Application Data
(63) Continuation-in-part of application No. 10/339,166, filed on Jan. 9, 2003.

(51) Int. Cl. G06F 17/60

(52) U.S. Cl. 705/7

(57) ABSTRACT

A process for developing a model and integrating the model into a business intelligence system includes: (a) defining at least one variable X to serve as an input to the model and at least one output variable Y to serve as an output of the model; (b) assessing whether there is sufficient data of sufficient quality to operate the model in the business intelligence system of the business, and creating a prototype design of the model; (c) further developing the prototype design of the model to produce a final model design, and validating output results provided by the final model design; (d) implementing the final model design to produce an implemented model, and developing an interface that enables a user to interact with the implemented model; and (e) integrating the implemented model and associated interface into the business intelligence system to provide an integrated model, and repetitively monitoring the accuracy of output results provided by the integrated model. A related method and system are also described.

This application is a continuation-in-part of U.S. patent application Ser. No. 10/339,166, filed on Jan. 9, 2003, entitled “Digital Cockpit,” which is incorporated by reference herein in its entirety.

### TECHNICAL FIELD

This invention relates to the development of a model for integration into a business intelligence system, and more particularly, to the development of a model having predictive capability for integration into a business intelligence system.

### BACKGROUND

Automated business analysis tools are becoming increasingly commonplace in many business environments. Such tools include a variety of models that provide information regarding the past performance of the business as well as its projected future course. Accordingly, a business currently operating without these tools may wish to acquire such tools to remain competitive with businesses that do employ these tools. Further, a business that currently uses these tools may want to continually revisit the appropriateness of their current suite of tools in view of current technology and business needs, which may require the business to periodically develop new business tools.

Businesses often develop new business tools in an ad hoc manner, that is, by adopting a somewhat arbitrary approach to carrying out the various steps involved in developing the business tools. This can result in inefficiencies in the development of these business tools. For instance, the unstructured approach to developing business tools may result in critical steps and considerations being overlooked. This may require the developers to repeat one or more processing steps involved in the development of the business tools. Further, the unstructured approach may result in the development of a final business tool that fails to fully meet the needs of the target customers. These kinds of problems can delay the development of business tools, as well as increase the costs associated with developing these tools.

There is therefore an exemplary need to provide a more efficient technique for the development of business tools.

### SUMMARY

A process for developing a model and integrating the model into a business intelligence system includes: (a) defining at least one variable X to serve as an input to the model and at least one output variable Y to serve as an output of the model; (b) assessing whether there is sufficient data of sufficient quality to operate the model in the business intelligence system of the business, and creating a prototype design of the model; (c) further developing the prototype design of the model to produce a final model design, and validating output results provided by the final model design; (d) implementing the final model design to produce an implemented model, and developing an interface that enables a user to interact with the implemented model; and (e) integrating the implemented model and associated interface into the business intelligence system to provide an integrated model, and repetitively monitoring the accuracy of output results provided by the integrated model. A related method and system are also described.

The rigor provided by the structured process enables a business to develop and deploy a business model in a time-efficient and resource-efficient manner.

### BRIEF DESCRIPTION OF THE DRAWINGS

FIG. 1 shows an exemplary business environment in which a business is using a digital cockpit.

FIG. 2 shows an exemplary system for implementing the digital cockpit shown in FIG. 1.

FIG. 3 shows an exemplary cockpit interface that can be used in the digital cockpits shown in FIGS. 1 and 2.

FIG. 4 shows an overview of an exemplary process for developing a model and for integrating the model into the digital cockpit.

FIGS. 5-9 shows exemplary details regarding operations performed in principal tasks of the process shown in FIG. 4.

FIG. 10 shows an exemplary system for use in carrying out the process shown in FIG. 4.

FIG. 11 shows an exemplary main interface page that can be presented to a user in the system shown in FIG. 10, where the main interface page presents information regarding the principal tasks within the process of FIG. 4.

FIG. 12 shows another interface page for presenting additional details regarding the principal tasks in the process of FIG. 4.

FIG. 13 shows another interface page for presenting information regarding a Y-selection scorecard tool.

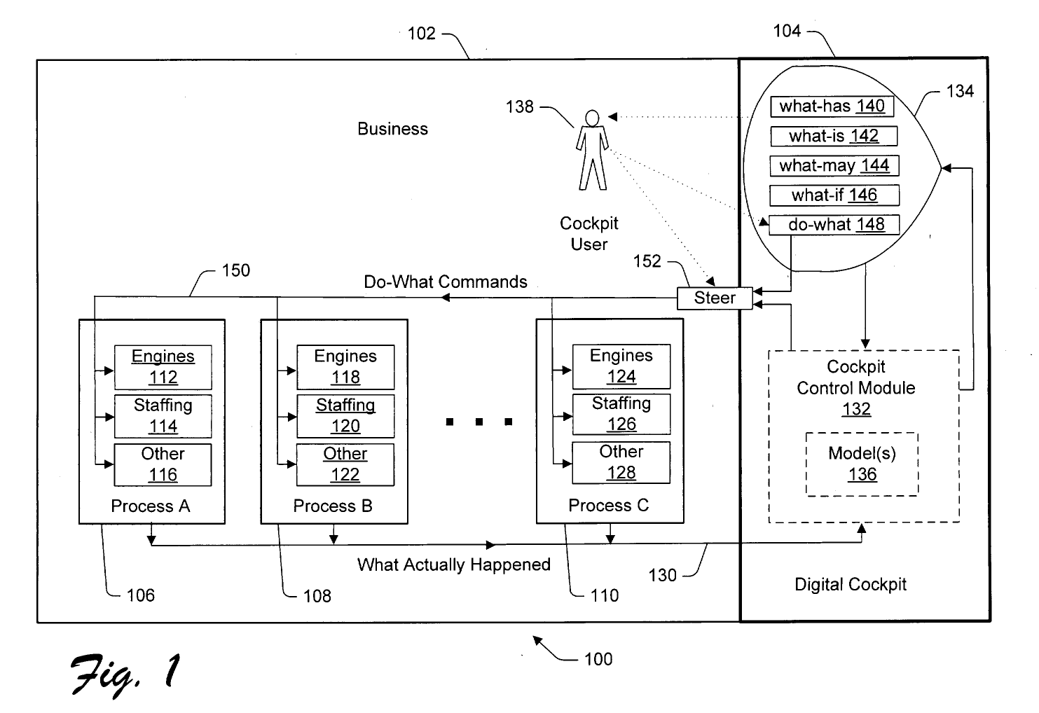

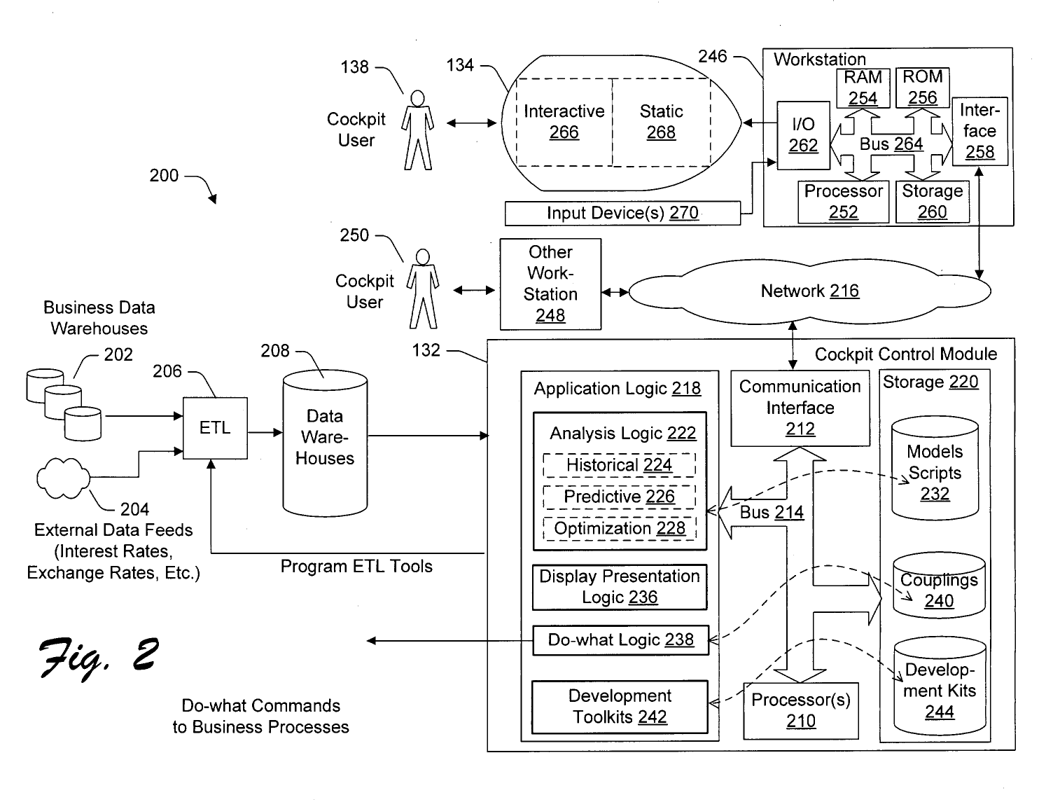

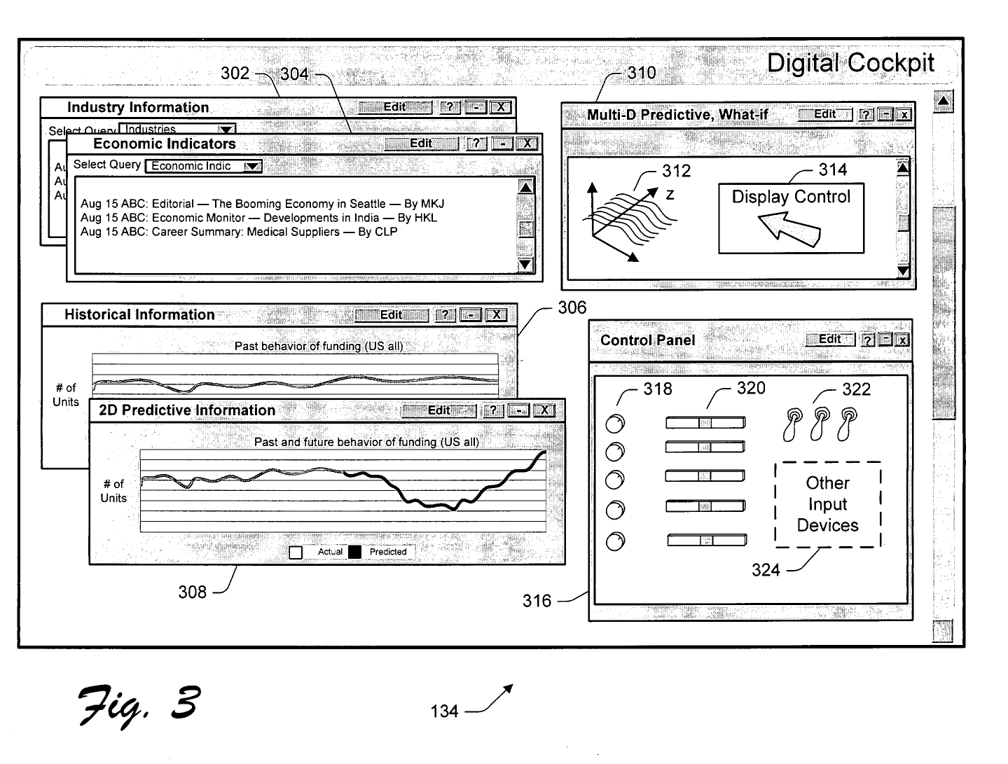

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure pertains to a technique for developing a model that performs business analysis, and to the integration of that model into a business intelligence system. By way of introduction, a business intelligence system generally refers to any kind of infrastructure for providing business analysis within a business. The business analysis that is featured in this disclosure pertains to business prediction. Generally, the term “prediction” is used broadly in this disclosure. This term encompasses any kind of projection of “what may happen” given any kind of input assumptions. In one case, a user may generate a prediction by formulating a forecast based on the past course of the business. Here, the input assumption is defined by the actual course of the business. In another case, a user may generate a prediction by inputting a set of assumptions that could be present in the business (but which do not necessarily reflect the current state of the business), which prompts the system to generate a forecast of what may happen if these assumptions are realized. Here, the forecast assumes more of a hypothetical (“what if”) character (e.g., “If X is put into place, then Y is likely to happen”).

The term “business” also has broad connotation. A business may refer to a conventional enterprise for providing goods or services for profit. The business may include a single entity, or a conglomerate entity comprising several different business groups or companies. Further, a business may include a chain of businesses formally or informally coupled through market forces to create economic value. The term “business” may also loosely refer to any organization, such as any non-profit organization, an academic organization, governmental organization, etc.

In one application, a business can use the development techniques described herein to develop a model for their own use, that is, for incorporation into the business intelligence system of their own business. For instance, a business may include multiple divisions or affiliated companies. In this case, the development technique can be used by one division within the business to develop a model for another division within the business. Alternatively, the development technique can be used by one business to provide a model for incorporation into the business intelligence system of another company that is not affiliated with the first-mentioned company. In general, the term “target” business refers to the business entity that is the recipient of the model, and will subsequently use the model in their day to day business operations. The term “developers” refers to the individuals whose role it is to develop the model for the target business.

To facilitate explanation, the following discussion will describe the development technique in the context of one specific business intelligence system, referred to a “digital cockpit.” In this context, the development technique entails developing a predictive model and then integrating this predictive model into a preexisting digital cockpit provided by the business. In another case, the business may not yet possess a digital cockpit. The development technique in this other case therefore entails providing both the model and the supporting digital cockpit infrastructure from “scratch.” However, it should be noted that the digital cockpit is merely one illustrative example. The principles described herein can be applied to develop models for integration into other kinds of business intelligence systems.

Prior to discussing the development technique, this disclosure provides introductory information regarding an exemplary digital cockpit. That is, Section A of this disclosure presents an overview of exemplary aspects of a digital cockpit. Section B describes a technique for developing a model for integration into the digital cockpit described in Section A.

A. Overview of a Digital Cockpit with Predictive Capability

FIG. 1 shows a high-level view of an environment 100 in which a business 102 is using a digital cockpit 104 to steer it in a desired direction. The business 102 is generically shown as including an interrelated series of processes (106, 108, . . . 110). The processes (106, 108, . . . 110) respectively perform allocated functions within the business 102. For instance, in a manufacturing environment, the processes (106, 108, . . . 110) may represent different stages in an assembly line for transforming raw material into a final product. In a finance-related business 102, the processes (106, 108, . . . 110) may represent different processing steps in transforming a business lead into a finalized transaction that confers some value to the business 102. Many other arrangements are possible. In general, the business processes (106, 108, . . . 110) may exist within a single business entity 102. Alternatively, one or more of the processes (106, 108, . . . 110) can extend to other entities, markets, and value chains (such as suppliers, distribution conduits, commercial conduits, associations, and providers of relevant information).

Each of these processes (106, 108, . . . 110) may draw from a collection of business resources. For instance, process 106 may draw from one or more engines 112. An “engine” 112 refers to any type of tool used by the process 106 in performing the allocated function of the process. In the context of a manufacturing environment, an engine 112 might refer to a machine for transforming materials from an initial state to a processed state. In the context of a finance-related environment, an engine 112 might refer to a technique for transforming input information into processed output information. For instance, in one finance-related application, an engine 112 may include one or more equations for transforming input information into output information. In other applications, a finance-related engine 112 may include more complex techniques for transforming information, such as various statistical techniques, rule-based techniques, artificial intelligence techniques, etc. In any case, the behavior of some of these engines 112 can be modeled as a so-called transfer function. A transfer function simulates the behavior of an engine by mapping a set of process inputs to projected process outputs. In other words, a transfer function translates at least one input into at least one output using a translation function, which may be a mathematical model or other form of mapping strategy.

Other resources in process 106 may include staffing resources 114. Staffing resources 114 refer to the personnel used by the business 102 to perform the functions associated with the process 106. For instance, in a manufacturing environment, the staffing resources 114 might refer to the workers required to run the machines within the process. In a finance-related environment, the staffing resources 114 might refer to personnel required to perform various steps involved in transforming information or “financial products” (e.g., contracts) from an initial state to a final processed state. Such individuals may include salesman, accountants, actuaries, etc.

Finally, the process 106 may generically include “other resources” 116. Such other resources 116 generally encompass any other feature or system of the process 106 that has a role in carrying out the function of the process 106. Such other resources 116 may include various control platforms (such as Supply Chain, Enterprise Resource Planning, Manufacturing-Requisitioning & Planning platforms, etc.), technical infrastructure, etc.

In like fashion, process 108 includes one or more engines 118, staffing resources 120, and other resources 122. Process 110 includes one or more engines 124, staffing resources 126, and other resources 128. Although the business 102 is shown as including three processes (106, 108, . . . 110), this is merely exemplary; depending on the particular business environment, more than three processes can be included, or less than three processes can be included.

The digital cockpit 104 collects information received from the processes (106, 108, . . . 110) via communication path 130, and then processes this information. Such communication path 130 may represent a digital network communication path, such as the Internet, an intranet network within a business enterprise 102, a LAN network, etc. The digital cockpit 104 itself includes a cockpit control module 132 coupled to a cockpit interface 134. The cockpit control module 132 includes one or more models 136. A model 136 transforms information collected by the processes (106, 108, . . . 110) into an output using a transfer function. As explained above, the transfer function of a model 136 maps one or more independent variables (e.g., one or more X variables) into one or more dependent variables (e.g., one or more Y variables). For example, a model 136 that performs a predictive function can map one or more X variables that pertain to historical information collected from the processes (106, 108, 110) into one or more predictive Y variables that forecast what is likely to happen in the future. Such predictive models 136 may include discrete event simulations, continuous simulations, Monte Carlo simulations, regressive analysis techniques, time series analyses, artificial intelligence analyses, extrapolation and logic analyses, etc. Other models 136 in the cockpit control module 132 can perform data collection steps. Such models 136 specify how information is to be extracted from one or more information sources and subsequently transformed into a desired form. Such models 136 are referred to in this disclosure as Extract-Transform-Load tools (i.e., ETL tools).

A subset of the models 136 in the cockpit control module 130 may be the same as some of the models 136 used in the engines (112, 118, 124) used in respective processes (106, 108, . . . 110). In this case, the same transfer functions are used in the cockpit control module 132 as are used in the day-to-day business operations within the processes (106, 108, . . . 110). Other models 136 used in the cockpit control module 132 are exclusive to the digital cockpit 104 (e.g., having no counterparts within the processes themselves (106, 108, . . . 110)). In the case where the cockpit control module 132 uses the same models 136 as one of the processes (106, 108, . . . 110), it is possible to store and utilize a single rendition of these models 136, or redundant copies of these models 136 can be stored in both the cockpit control module 132 and the processes (106, 108, . . . 110).

A cockpit user 138 interacts with the digital cockpit 104 via the cockpit interface 134. The cockpit user 138 can include any individual within the business 102 (or potentially outside the business 102). The cockpit user 138 frequently will have a decision-maker role within the organization, such as a managerial role (e.g., a chief executive officer).

The cockpit interface 134 presents various fields of information regarding the course of the business 102 to the cockpit user 138 based on the outputs provided by the models 136. For instance, the cockpit interface 134 may include a field 140 for presenting information regarding the past course of the business 102 (referred to as a “what has happened” field, or a “what-has” field for brevity). The cockpit interface 134 may include another field 142 for presenting information regarding the present state of the business 102 (referred to as “what is happening” field, or a “what-is” field for brevity). The cockpit interface 134 may also include another field 144 for presenting information regarding the projected future course of the business 102 (referred to as a “what may happen” field, or “what-may” field for brevity).

In addition, the cockpit interface 134 presents another field 146 for receiving hypothetical case assumptions from the cockpit user 138 (referred to as a “what-if” field). More specifically, the what-if field 146 allows the cockpit user 138 to enter information into the cockpit interface 134 regarding hypothetical or actual conditions within the business 102. The digital cockpit 104 will then compute various consequences of the identified conditions within the business 102 and present the results to the cockpit user 138 for viewing in the what-if field 146.

After analyzing information presented by fields 140, 142, 144, and 146, the cockpit user 138 may be prepared to take some action within the business 102 to steer the business 102 in a desired direction based on some objective in mind (e.g., to increase revenue, or to increase sales volume, etc.). To this end, the cockpit interface 134 includes another field 148 for allowing the cockpit user 138 to enter commands that specify what the business 102 is to do in response to information (referred to as “do-what” commands for brevity). More specifically, the do-what field 148 can include an assortment of interface input mechanisms (not shown), such as various graphical knobs, sliding bars, text entry fields, etc. The business 102 includes a communication path 150 for forwarding instructions generated by the do-what commands to the processes (106, 108, . . . 110). Such communication path 150 can be implemented as a digital network communication path, such as the Internet, an intranet within a business enterprise 102, a LAN network, etc. In one implementation, the communication path 130 and communication path 150 can be implemented as the same digital network.

The do-what commands can affect a variety of changes within the processes (106, 108, . . . 110), depending on the particular business environment in which the digital cockpit 104 is employed. In one case, the do-what commands affect a change in the engines (112, 118, 124) used in the respective processes (106, 108, . . . 110). Such modifications may include changing parameters used by the engines (112, 118, 124), changing the strategies used by the engines (112, 118, 124), changing the input data fed to the engines (112, 118, 124), or changing any other aspect of the engines (112, 118, 124). In another case, the do-what commands affect a change in the staffing resources (114, 120, 126) used by the respective processes (106, 108, 110). Such modifications may include changing the number of workers assigned to specific steps within the processes (106, 108, . . . 110), changing the amount of time spent by the workers on specific steps in the processes (106, 108, . . . 110), changing the nature of steps assigned to the workers, or changing any other aspect of the staffing resources (114, 120, 126). Finally, the do-what commands can generically make other changes to the other resources (116, 122, 128), depending on the context of the specific business application.

The business 102 provides other mechanisms for affecting changes in the processes (106, 108, . . . 110) besides the do-what field 148. Namely, in one implementation, the cockpit user 138 can directly make changes to the processes (106, 108, . . . 110) without transmitting instructions through the communication path 150 via the do-what field 148. In this case, the cockpit user 138 can directly visit and make changes to the engines (112, 118, 124) in the respective processes (106, 108, . . . 110). Alternatively, the cockpit user 138 can verbally instruct various staff personnel (114, 120, 126) involved in the processes (106, 108, . . . 110).

In still another case, the cockpit control module 132 can include functionality for automatically analyzing information received from the processes (106, 108, 110), and then automatically generating do-what commands to appropriate target resources within the processes (106, 108, . . . 110). As will be described in greater detail below, such automatic control can include mapping various input conditions to various instructions to be propagated into the processes (106, 108, . . . 110). Such automatic control of the business 102 can therefore be likened to an automatic pilot provided by a vehicle. In yet another implementation, the cockpit control module 132 generates a series of recommendations regarding different courses of actions that the cockpit user 138 might take, and the cockpit user 138 exercises human judgment in selecting a control strategy from among the recommendations (or in selecting a strategy that is not included in the recommendations).

A steering control interface 152 generally represents the cockpit user 138's ability to make changes to the business processes (106, 108, . . . 110), whether these changes are made via the do-what field 148 of the cockpit interface 134, via conventional and manual routes, or via automated process control. To continue with the metaphor of a physical cockpit, the steering control interface 152 generally represents a steering stick used in an airplane cockpit to steer the airplane, where such a steering stick may be controlled by the cockpit user by entering commands through a graphical user interface. Alternatively, the steering stick can be manually controlled by the user, or automatically controlled by an “auto-pilot.”

Whatever mechanism is used to affect changes within the business 102, such changes can also include modifications to the digital cockpit 104 itself. For instance, the cockpit user 138 can also make changes to the models 136 used in the cockpit control module 132. Such changes may comprise changing the parameters of a model 136, or entirely replacing one model 136 with another model 136, or supplementing the existing models 136 with additional models 136. Moreover, the use of the digital cockpit 104 may comprise an integral part of the operation of different business processes (106, 108, . . . 110). In this case, cockpit user 138 may want to change the models 136 in order to affect a change in the processes (106, 108, . . . 110).

FIG. 2 shows an exemplary architecture 200 for implementing the functionality described in FIG. 1. The digital cockpit 104 receives information from a number of sources both within and external to the business 102. For instance, the digital cockpit 104 receives data from business data warehouses 202. These business data warehouses 202 store information collected from the business 102 in the normal course of business operations. In the context of the FIG. 1 depiction, the business data warehouses 202 can store information collected in the course of performing the steps in processes (106, 108, . . . 110). Such business data warehouses 202 can be located together at one site, or distributed over multiple sites. The digital cockpit 104 also receives information from one or more external sources 204. Such external sources 204 may represent third party repositories of business information, such as information regarding market performance, etc.

An Extract-Transform-Load (ETL) module 206 extracts information from the business data warehouses 202 and the external sources 204, and performs various transformation operations on such information. The transformation operations can include: 1) performing quality assurance on the extracted data to ensure adherence to pre-defined guidelines, such as various expectations pertaining to the range of data, the validity of data, the internal consistency of data, etc; 2) performing data mapping and transformation, such as mapping identical fields that are defined differently in separate data sources, eliminating duplicates, validating cross-data source consistency, providing data convergence (such as merging records for the same customer from two different data sources), and performing data aggregation and summarization; 3) performing post-transformation quality assurance to ensure that the transformation process does not introduce errors, and to ensure that data convergence operations did not introduce anomalies, etc. The ETL module 206 also loads the collected and transformed data into a data warehouse 208. The ETL module 206 can include one or more selectable tools for performing its ascribed steps, collectively forming an ETL toolset. For instance, the ETL toolset can include one of the tools provided by Informatica Corporation of Redwood City, Calif., and/or one of the tools provided by DataJunction Corporation of Austin, Tex. Still other tools can be used in the ETL toolset, including tools specifically tailored by the business 102 to perform unique in-house functions.

The data warehouse 208 may represent one or more storage devices. If multiple storage devices are used, these storage devices can be located in one central location or distributed over plural sites. Generally, the data warehouse 208 captures, scrubs, summarizes, and retains the transactional and historical detail necessary to monitor changing conditions and events within the business 102. Various known commercial products can be used to implement the data warehouse 208, such as various data storage solutions provided by the Oracle Corporation of Redwood Shores, Calif.

Although not shown in FIG. 2, the architecture 200 can include other kinds of storage devices and strategies. For instance, the architecture 200 can include an OnLine Analytical Processing (OLAP) server (not shown). An OLAP server provides an engine that is specifically tailored to perform data manipulation of multi-dimensional data structures. Such multi-dimensional data structures arrange data according to various informational categories (dimensions), such as time, geography, etc. The dimensions serve as indices for retrieving information from a multi-dimensional array of information, such as so-called OLAP cubes.

The architecture 200 can also include a digital cockpit data mart (not shown) that culls a specific set of information from the data warehouse 208 for use in performing a specific subset of steps within the business enterprise 102. For instance, the information provided in the data warehouse 208 may serve as a global resource for the entire business enterprise 102. The information culled from this data warehouse 208 and stored in the data mart (not shown) may correspond to the specific needs of a particular group or sector within the business enterprise 102.

The information collected and stored in the above-described manner is fed into the cockpit control module 132. The cockpit control module 132 can be implemented as any kind of computer device, including one or more processors 210, various memory media (such as RAM, ROM, disc storage, etc.), a communication interface 212 for communicating with an external entity, a bus 214 for communicatively coupling system components together, as well as other computer architecture features that are known in the art. In one implementation, the cockpit control module 132 can be implemented as a computer server coupled to a network 216 via the communication interface 212. In this case, any kind of server platform can be used, such as server functionality provided by iPlanet, produced by Sun Microsystems, Inc., of Santa Clara, Calif. The network 216 can comprise any kind of communication network, such as the Internet, a business intranet, a LAN network, an Ethernet connection, etc. The network 216 can be physically implemented as hardwired links, wireless links, a combination of hardwired and wireless links, or some other architecture.

The memory media within the cockpit control module 132 can be used to store application logic 218 and record storage 220. For instance, the application logic 218 can constitute different modules of program instructions stored in RAM memory. The record storage 220 can constitute different databases for storing different groups of records using appropriate data structures. More specifically, the application logic 218 includes analysis logic 222 for performing different kinds of analytical operations. For example, the analysis logic 222 includes historical analysis logic 224 for processing and summarizing historical information collected from the business 102, and/or for presenting information pertaining to the current status of the business 102. The analysis logic 222 also includes predictive analysis logic 226 for generating business forecasts based on historical information collected from the business 102. Such predictions can take the form of extrapolating the past course of the business 102 into the future, and for generating error information indicating the degrees of confidence associated with its predictions. Such predictions can also take the form of generating predictions in response to an input what-if scenario. A what-if scenario refers to a hypothetical set of conditions (e.g., cases) that could be present in the business 102. Thus, the predictive logic 226 would generate a prediction that provides a forecast of what might happen if such conditions (e.g., cases) are realized through active manipulation of the business processes (106, 108, . . . 110).

The analysis logic 222 further includes optimization logic 228. The optimization logic 228 computes a collection of model results for different input case assumptions, and then selects a set of input case assumptions which provides preferred model results. More specifically, this step can be performed by methodically varying different variables in the input case assumption and comparing the model output with respect to a predefined goal (such as an optimized revenue value, or optimized sales volume, etc.). The case assumptions that provide the “best” model results with respect to the predefined goal are selected, and then these case assumptions can be actually applied to the business processes (106, 108, . . . 110) to realize the predicted “best” model results in actual business practice.

A variety of commercially available software products can be used to implement the analysis logic. To name but a small sample, the analysis logic 222 can use one or more of the family of Crystal Ball products produced by Decisioneering, Inc. of Denver Colo., one or more of the Mathematica products produced by Wolfram, Inc. of Champaign Ill., one or more of the SAS products produced by SAS Institute Inc. of Cary, N.C., etc. In general, such tools can execute regression analysis, time-series computations, cluster analysis, simulation, and other types of analyses.

The storage logic 220 can include a database 232 that stores various models scripts. Such models scripts provide instructions for running one or more analytical tools in the analysis logic 222. As used in this disclosure, a model 136 refers to an integration of the tools provided in the analysis logic 222 with the model scripts provided in the database 232.

The application logic 218 also includes other programs, such as display presentation logic 236. The display presentation logic 236 performs various steps associated with displaying the output results of the analyses performed by the analysis logic 222. Such display presentation steps can include presenting probability information that conveys the confidence associated with the output results using different display formats. The display presentation logic 236 can also include functionality for rotating and scaling a displayed response surface to allow the cockpit user 138 to view the response surface from different “vantage points,” to thereby gain better insight into the characteristics of the response surface.

The application logic 218 also includes do-what logic 238. The do-what logic 238 includes the program logic used to develop and/or propagate commands into the business 102 for affecting changes in the business 102. For instance, as described in connection with FIG. 1, such changes can constitute changes to engines (112, 118, 124) used in business processes (106, 108, . . . 110), changes to staffing resources (114, 120, 126) used in business processes (106, 108, . . . 110), or other changes. In one implementation, the do-what logic 238 is used to receive do-what commands entered by the cockpit user 138 via the cockpit interface 134. Such cockpit interface 134 can include various graphical knobs, slide bars, switches, etc. for receiving the user's commands. In another implementation, the do-what logic 238 is used to automatically generate the do-what commands in response to an analysis of data received from the business processes (106, 108, . . . 110). In either case, the do-what logic 238 can rely on a coupling database 240 in developing specific instructions for propagation throughout the business 102. For instance, the do-what logic 238 in conjunction with the database 240 can map various entered do-what commands into corresponding instructions for affecting specific changes in the resources of business processes (106, 108, . . . 110). This mapping can rely on rule-based logic. For instance, an exemplary rule might specify: “If a user enters instruction X, then affect change Y to engine resource 112 of process 106, and affect change Z to staffing resource 120 of process 108.” Such rules can be stored in the couplings database 240, and this information may effectively reflect empirical knowledge garnished from the business processes (106, 108, . . . 110) over time (e.g., in response to observed causal relationships between changes made within a business 102 and their respective effects). Effectively, then, this coupling database 240 constitutes the “control coupling” between the digital cockpit 104 and the business processes (106, 108, . . . 110) which it controls in a manner analogous to the control coupling between a control module of a physical system and the subsystems which it controls. In other implementations, still more complex strategies can be used to provide control of the business 102, such as artificial intelligence systems (e.g., expert systems) for translating a cockpit user's 138 commands to the instructions appropriate to affect such instructions.

Finally, the application logic 218 also includes development toolkit logic 242 and an associated development toolkit data storage 244. These features are described in Section B.3 of this disclosure.

The cockpit user 138 can receive information provided by the cockpit control module 132 using different devices or different media. FIG. 2 shows the use of computer workstations 246 and 248 for presenting cockpit information to cockpit users 138 and 250, respectively. However, the cockpit control module 132 can be configured to provide cockpit information to users using laptop computing devices, personal digital assistant (PDA) devices, cellular telephones, printed media, or other technique or device for information dissemination (none of which are shown in FIG. 2). The exemplary workstation 246 includes conventional computer hardware, including a processor 252, RAM 254, ROM 256, a communication interface 258 for interacting with a remote entity (such as network 216), storage 260 (e.g., an optical and/or hard disc), and an input/output interface 262 for interacting with various input devices and output devices. These components are coupled together using bus 264. An exemplary output device includes the cockpit interface 134. The cockpit interface 134 can present an interactive display 266, which permits the cockpit user 138 to control various aspects of the information presented on the cockpit interface 134. Cockpit interface 134 can also present a static display 268, which does not permit the cockpit user 138 to control the information presented on the cockpit interface 134. The application logic for implementing the interactive display 266 and the static display 268 can be provided in the memory storage of the workstation (e.g., the RAM 254, ROM 256, or storage 260, etc.), or can be provided by a computing resource coupled to the workstation 246 via the network 216, such as display presentation logic 236 provided in the cockpit control module 132.

Finally, an input device 270 permits the cockpit user 138 to interact with the workstation 246 based on information displayed on the cockpit interface 134. The input device 270 can include a keyboard, a mouse device, a joy stick, a data glove input mechanism, throttle input mechanism, track ball input mechanism, a voice recognition input mechanism, a graphical touch-screen display field, etc., or any combination of these devices.

FIG. 3 provides an exemplary cockpit interface 134 for one business environment. The interface can include a collection of windows (or more generally, display fields) for presenting information regarding the past, present, and future course of the business 102, as well as other information. For example, windows 302 and 304 present information regarding the current business climate (i.e., environment) in which the business 102 operates. That is, for instance, window 302 presents industry information associated with the particular type of business 102 in which the digital cockpit 104 is deployed, and window 304 presents information regarding economic indicators pertinent to the business 102. Of course, this small sampling of information is merely illustrative; a great variety of additional information can be present regarding the business environment in which the business 102 operates.

Window 306 provides information regarding the past course (i.e., history) of the business 102, as well as its present state. Window 308 provides information regarding both the past, current, and projected future condition of the business 102. The cockpit control module 132 can generate the information shown in window 308 using one or more models 136. Although not shown, the cockpit control module 132 can also calculate and present information regarding the level of confidence associated with the business predictions shown in window 308. Again, the predictive information shown in windows 306 and 308 is strictly illustrative; a great variety of additional presentation formats can be provided depending on the business environment in which the business 102 operates and the design preferences of the cockpit designer.

The cockpit interface 134 can also present interactive information, as shown in window 310. This window 310 includes an exemplary multi-dimensional (e.g., three dimensional) response surface 312. For instance, the response surface 312 can present information regarding the projected future course of business, where the z axis of the response surface 312 represents different slices of time. The window 310 can further include a display control interface 314 which allows the cockpit user 138 to control the presentation of information presented in the window 310. For instance, in one implementation, the display control interface 314 can include an orientation arrow which allows the cockpit user 138 to select a particular part of the displayed response surface 312, or which allows the cockpit user 138 to select a particular vantage point from which to view the response surface 312.

The cockpit interface 134 further includes another window 316 that provides various control mechanisms. Such control mechanisms can include a collection of graphical input knobs or dials 318, a collection of graphical input slider bars 320, a collection of graphical input toggle switches 322, as well as various other graphical input devices 324 (such as data entry boxes, radio buttons, etc.). These graphical input mechanisms (318, 320, 322, 324) are implemented, for example, as touch sensitive fields in the cockpit interface 134. Alternatively, these input mechanisms (318, 320, 322, 324) can be controlled via other input devices, such as a keyboard.

In one use, the input mechanisms (318, 320, 322, 324) provided in the window 320 can be used to input various what-if assumptions. The entry of this information prompts the digital cockpit 104 to generate predictions based on the input what-if assumptions. For instance, assume that the success of a business 102 can be represented by a dependent output variable Y, such as revenue, sales volume, etc. Further assume that the dependent variable Y is a function of a set of independent X variables, e.g., Y=f(X₁, X₂, X₃, . . . Xₙ), where “f” refers to a function for mapping the independent variables (X₁, X₂, X₃, . . . Xₙ) into the dependent variable Y. An X variable is said to be “actionable” when it corresponds to an aspect of the business 102 that the business 102 can deliberately manipulate. For instance, presume that the output variable Y is a function, in part, of the size of the business's 102 sales force. A business 102 can control the size of the workforce by hiring additional staff, transferring existing staff to other divisions, laying off staff, etc. Hence, the size of the workforce represents an actionable X variable. In the context of FIG. 3, the graphical input devices (318, 320, 322, 324) can be associated with such actionable X variables.

To simulate a what-if scenario, the cockpit user 138 adjusts the input devices (318, 320, 322, 324) to select a particular permutation of actionable X variables. The digital cockpit 104 responds by simulating how the business 102 would react to this combination of input actionable X variables as if these actionable X variables were actually implemented within the business 102. The digital cockpit's 104 predictions can be presented in the window 310, which displays a three-dimensional response surface 312 that maps the output result Y as a function of other variables, such as time, or possibly one of the actionable X variables

In another use, the input mechanisms (318, 320, 322, 324) provided in window 316 can be used to enter do-what commands. As explained above, the digital cockpit 104 propagates instructions based on the do-what commands to different target processes (106, 108, . . . 110) in the business 102 to affect specified changes in the business 102.

Additional features of the digital cockpit 104 can be found in application Ser. No. 10/339,166, filed on Jan. 9, 2003, entitled, “Digital Cockpit.” Other features of the digital cockpit 104 can be found in: application No. 10/______ (GE1021US), entitled, “PERFORMING WHAT-IF PREDICTIONS USING A BUSINESS INTELLIGENCE SYTEM,” filed on the same date as the present application and incorporated herein by reference in its entirety; application No. 10/______ (GE1-022US), entitled, “CONTROLLING A BUSINESS USING A BUSINESS INTELLIGENCE SYSTEM,” filed on the same date as the present application and incorporated herein by reference in its entirety; application No. 10/______ (GE1-020US), entitled, “GENERATING BUSINESS ANALYSIS RESULTS IN ADVANCE OF A REQUEST FOR THE RESULTS,” filed on the same date as the present application and incorporated herein by reference in its entirety; and application No. 10/______ (GE1-023US), entitled, “VISUALIZING BUSINESS ANALYSIS RESULTS,” filed on the same date as the present application and incorporated herein by reference in its entirety.

B. Development Technique

B.1. Process for Developing a Model and Integrating the Model into a Digital Cockpit

B.1 (a). Overview of the Process

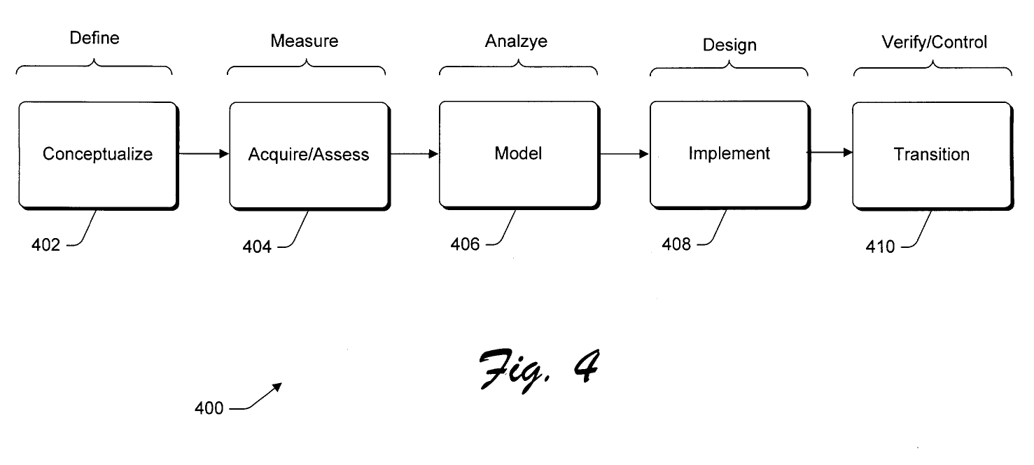

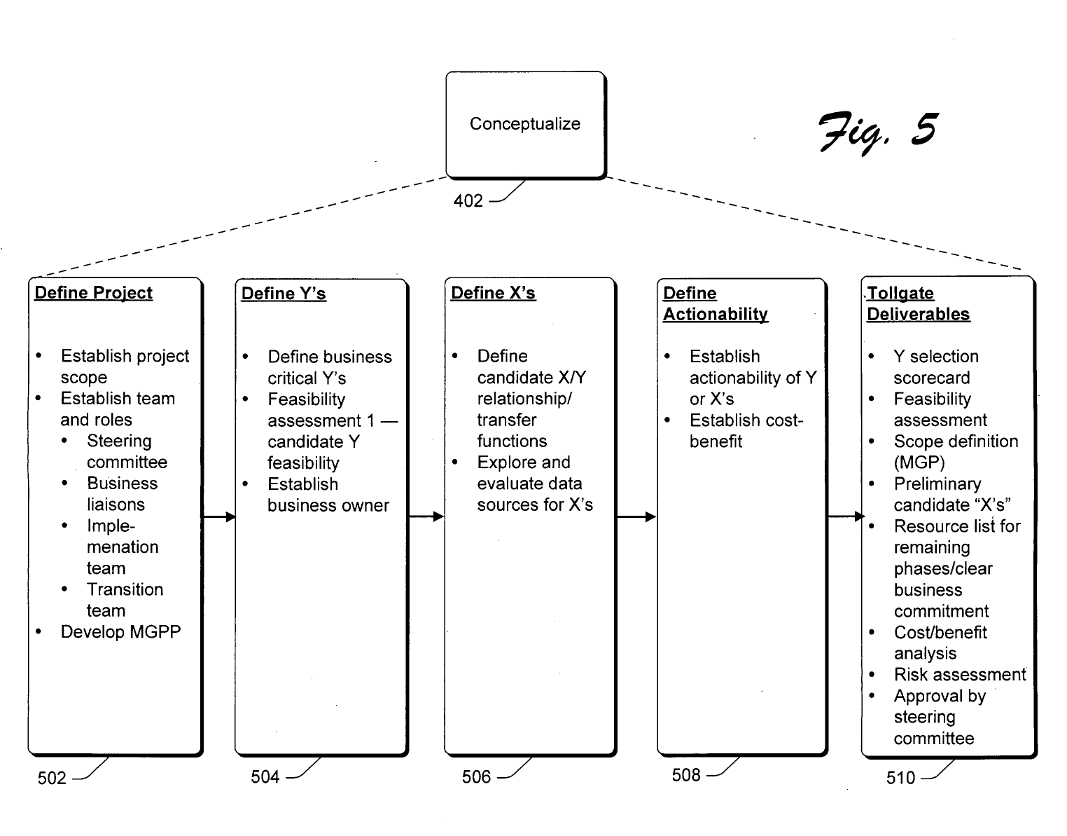

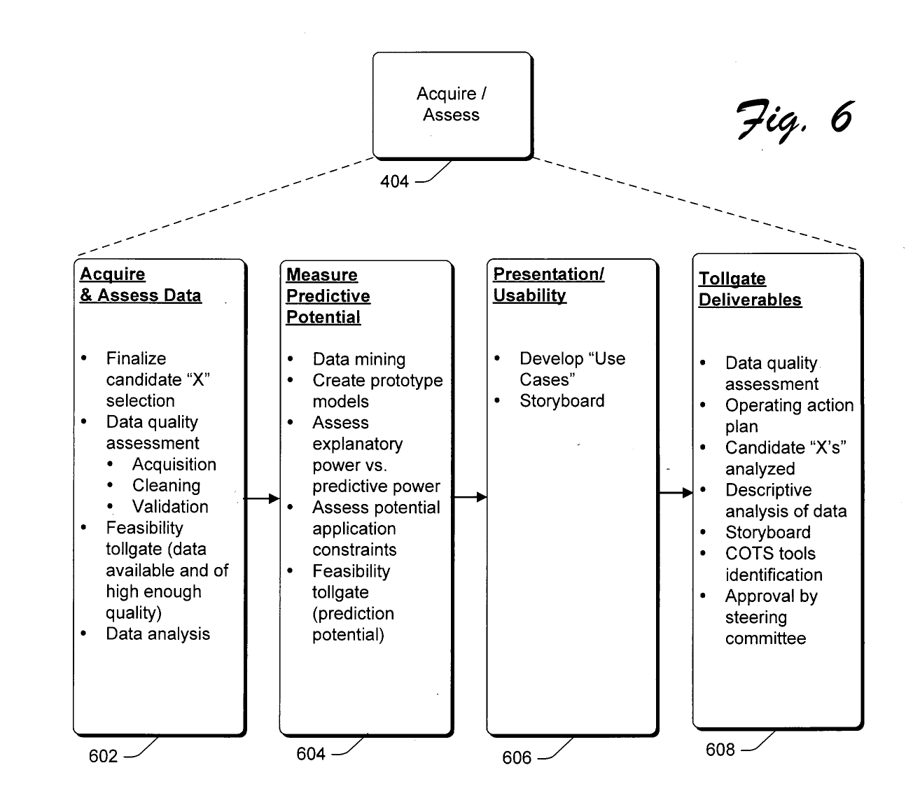

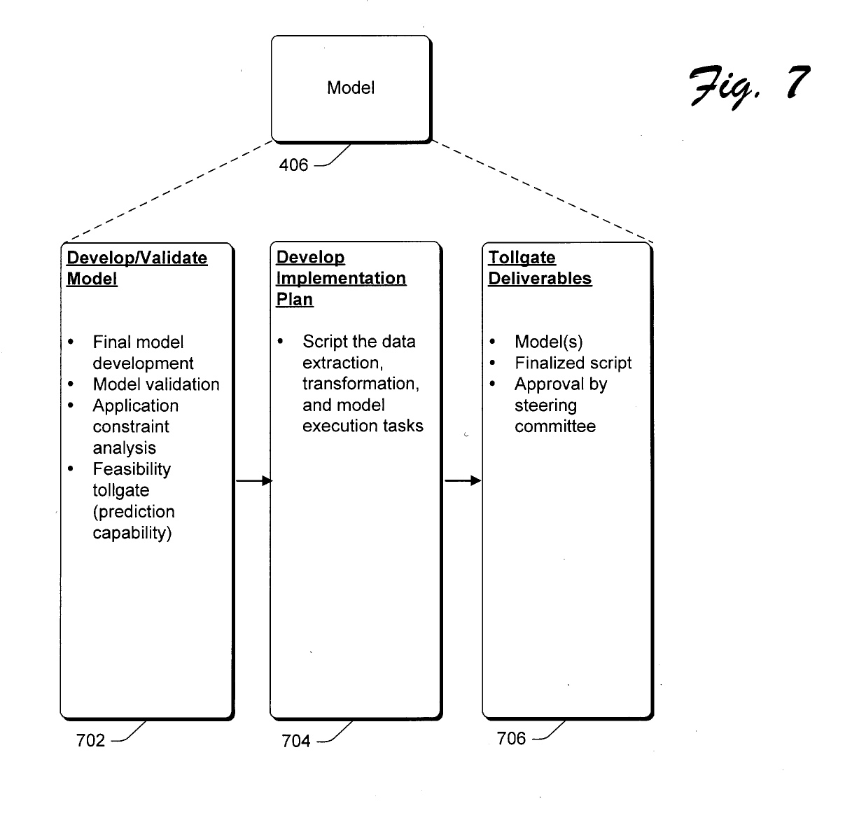

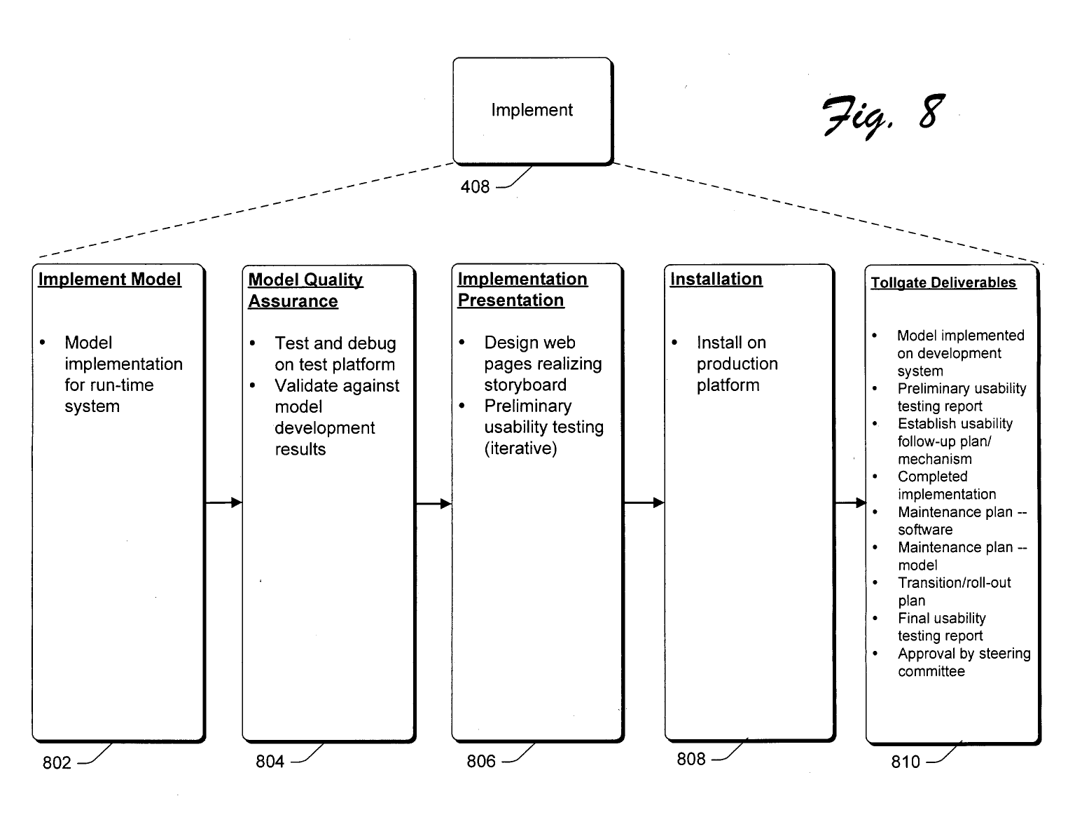

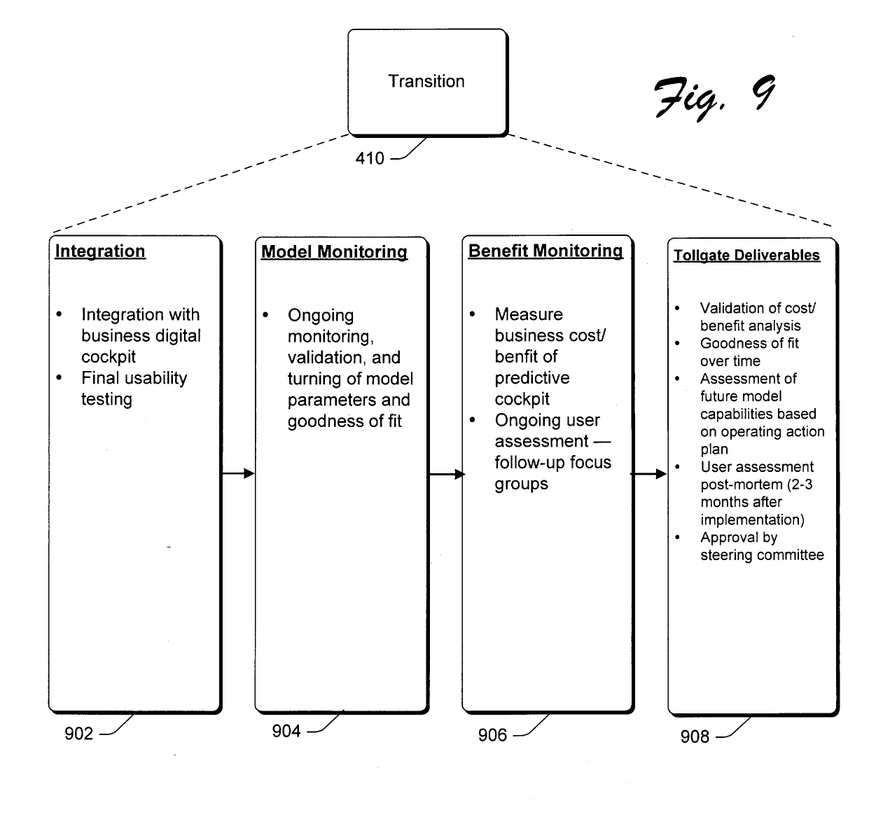

The following section describes an exemplary technique for developing a predictive model for integration into digital cockpit (or other kind of business intelligence system). To begin with, FIG. 4 shows an overview of a process 400 for developing a model and then integrating the model into the digital cockpit of a target business. Five principal tasks are illustrated in FIG. 4, including conceptualize 402, acquire/assess 404, model 406, implement 408, and transition 410.

By way of overview, the principal task (conceptualize) 402 entails at least defining at least one variable X to serve as an input to the model and at least one output variable Y to serve as an output of the model. The second principal task 404 (acquire/assess) entails at least assessing whether there is sufficient data of sufficient quality to operate the model in the business intelligence system of the business, and creating a prototype design of the model. The third principal task 406 (model) entails at least further developing the prototype design of the model to produce a final model design, and validating output results provided by the final model design. The fourth principal task 408 (implement) entails at least implementing the final model design to produce an implemented model, and developing an interface that enables a user to interact with the implemented model. The fifth principal task 410 (transition) entails at least integrating the implemented model and associated interface into the business intelligence system to provide an integrated model, and repetitively monitoring the accuracy of the output results provided by the integrated model.

On a higher level of abstraction, the flow in process 400 can be divided into multiple phases. The correspondence between the phases and the principal tasks may not be exact. Nevertheless, a definition phase generally corresponds to the first principal task 402 (conceptualize). A measurement phase generally corresponds to the second principal task 404 (acquire/assess). An analyze phase generally corresponds to the third principal task 406 (model). A design phase generally corresponds to the fourth principal task 408 (implement). And a verify/control phase generally corresponds to the fifth principal task 410 (transition). The phases (define, measure, analyze, design, and verify/control) collectively represent a structured approach to developing projects. The basic purpose of these phases is indicated by their descriptive labels, and, in any event, is clarified in the following discussion.

Each principal task may produce one or more outputs, referred to as “deliverables.” The deliverables may comprise documents or related products (e.g., systems, program code, etc.) generated in the course of performing the principal tasks. Further, the principal tasks generally terminate in approval decision steps. These decision steps correspond to junctures in the process 400 where it is deemed prudent to secure the approval of those assigned the role of overseeing and managing the process 400. The effect of the decision steps is to halt the project at various stages of the process 400 and demand that the process 400 satisfy prescribed criteria. In this sense, the approval steps serve as tollgates or checkpoints. A developing project that fails to satisfy the prescribed criteria will not advance to the next stage of development (e.g., it will not advance to the next principal task). If this is the case, the developers have two choices. They may attempt to revise the project by repeating one or more of the steps in previous principal tasks. Alternatively, the developers may be forced to abandon the project if the deficiency is deemed irresolvable.

Each of the principal tasks shown in FIG. 4 includes multiple steps associated therewith. Each step, in turn, may include multiple substeps associated therewith. The substeps generally refer to a series of specific actions that should be carried out to accomplish the main objective of their associated step. The hierarchical arrangement of tasks, steps, and substeps provides structure and rigor in performing the process 400, and helps reduce confusion and wasted resources in the carrying out the development project. However, the specific collection of tasks, steps, and substeps described below is exemplary. Different businesses may adopt a different collection of tasks, steps, and substeps, and/or a different ordering of tasks, steps, and substeps.

Having described the process 400 in general terms, it is now possible to discuss the individual principal tasks, steps, and substeps involved in the process 400 in greater detail.

B.1 (b). The First Principal Task: Conceptualize

The conceptualize principal task 402 includes a first step 502 that pertains to defining the project. The step 502 of defining the project includes a first substep of establishing the scope of the project. The scope of the project defines the basic aims of the project, that is, by setting forth, in general terms, the problem that the project is intended to address, and how the project intends to address it.

The first step 502 includes another substep of defining the individuals who will implement different aspects of the project, as well as the specific responsibilities (e.g., roles) assigned to each of these individuals. For instance, this substep establishes a “steering committee,” comprising a group of individuals assigned the role of generally shaping the course of the evolving project by coordinating the efforts of others, assessing the progress of the project at various tollgate checkpoints, taking corrective action when needed, etc. The second substep also involves defining a group of business liaisons, comprising one or more individuals who will closely interact with the target business (that is, the business for which the digital cockpit is being developed). This substep also involves establishing an implementation team, defining those individuals who will implement the model, and a transition team, defining those individuals who coordinate the integration of the model into the digital cockpit of the target business, and subsequently monitor its accuracy at periodic intervals.

Finally, the step 502 also involves developing a multi-generational project plan (MGPP). The MGPP defines a strategy for implementing the digital cockpit in a series of generations as time progresses. Each generation provides the digital cockpit with a different collection of features. That is, the second generation includes more enhanced features than the first generation, and the third generation includes more enhanced features than the second generation, and so on. Implementing the digital cockpit in multiple generations allows the target business to make use of the digital cockpit as soon as possible. Further, implementing the digital cockpit in multiple generations allows the developers to collect data regarding the strengths and weaknesses of the digital cockpit based on feedback from users, which can be used to provide a more satisfactory solution in later generations of the digital cockpit (that is, by correcting perceived problems in earlier generations of the digital cockpit).

An exemplary MGPP can specify how each generation differs from its predecessor with respect to a number of specified categories of features. In one exemplary case, such categories can include: a) information granularity; b) refresh rate; c) data feed method; d) audience; e) presentation; f) secure access; g) time variance; h) analysis; i) event triggers; j) escalation; and k) monitor and validate metrics. The category of “information granularity” refers to the amount of detail provided by the digital cockpit (the objective being to present increasingly greater amounts of information in successive generations). The category of “refresh rate” pertains to the frequency at which information fed to the digital cockpit is updated (the objective being to provide successively more frequent updates, culminating in, perhaps, substantially real-time presentation of current information to the digital cockpit). The category of “data feed method” refers to techniques used to collect data (the objective being to provide increasingly automated and accurate data collection techniques). The category of “audience” pertains to the group of individuals who are permitted access to the digital cockpit (the objective being to allow increasingly greater numbers of individuals to access the digital cockpit within the organization). The category of “presentation” refers to the functionality used to present results to the cockpit interface (the objective being to make this functionality progressively more versatile, powerful, user-friendly, etc.). The category of “secure access” refers to the security provisions provided by the digital cockpit (the objective being to present increasingly more secure yet accessible data resources to the cockpit users). The category of “time variance” refers to the window of time in which the digital cockpit permits the cockpit user to view business results (the objective being to make this window increasingly more inclusive, e.g., by allowing the user to view business results for past, present, and future periods; this depends on providing reliable historical data regarding the operation of the business). The category of “event triggers” refers to the techniques used by the business to provide notifications to cockpit users regarding events that occur within the business or marketplace (the objective being to provide increasingly sophisticated, useful, and reliable notifications to the cockpit users). The category of “escalation” refers to the processes used by the digital cockpit to responds to an event within the business that requires action (the objective being to make escalation procedures successively more flexible, powerful, useful, etc.). Finally, the “monitor and validate metrics” category refers to the procedures used by the business to ensure that the models are providing accurate results (the objective being to provide procedures that are increasingly more apt to identify model drift before it results in negative consequences for the business). These categories are merely exemplary; different businesses may identify different categories that are more appropriate to their particular business environment.

The conceptualize principal task 502 includes a second step 504 that pertains to defining the Y variables to be modeled by the digital cockpit. As described in Section A of this disclosure, a digital cockpit model transforms one or more independent variables (X variables) into one or more dependent variables (Y variables), or in, other words, Y=f(X₁, X₂, X₃, . . . Xₙ), where X₁, X₂, X₃ and Xₙ refer to different X variables that are transformed into the Y variable using the function “f.” A Y variable generally corresponds to some metric that tracks the success of the business, or, more generally, is of interest to the business in assessing its success in the marketplace. The model under development can specifically perform a predictive function, meaning that the Y variable that it provides reflects the forecasted performance of the business based on a set of input assumptions (e.g., specified by respective X variables). The prediction generated by the model also takes account of the past performance of the business, as reflected by information collected from the business and stored in data ware house 208 (shown in FIG. 2). Exemplary Y variables may include net income, new business volume, level of risk, write off, etc.

More specifically, the step 504 includes a first substep of defining “critical Y variables.” A Y variable is deemed critical if it is somehow directly relevant to assessing the well-being of the target business. Section B.1(c) provides additional information regarding a tool (the “Y selection scorecard”) that can be used to facilitate the identification of critical Y variables.

Step 504 includes another substep of assessing the feasibility of the selected Y variables. The feasibility of a Y variable generally reflects how practical it is to measure the metric represented by the Y variable in an actual business environment. For instance, the developers may have selected a Y variable that reflects the level of competition in a particular industry. However, competition may be a concept that is difficult to parameterize and measure in an actual business environment. Accordingly, it would serve no benefit to develop a model which provided a measure of competition, since there is no feasible way of validating the results provided by the model. This substep may therefore have the effect of reducing an initial list of candidate Y variables to a smaller list. The smaller list of candidate Y variables would include only those Y variables that can be practically and reliably quantified within an actual business environment.

Step 504 includes another substep of establishing business owners for each of the identified critical Y variables. A business owner represents someone who has ample familiarity with one aspect of the business—or may even manage that aspect of the business and thus has great confidence that the selected Y variable is a metric that is commonly used to assess the success of that aspect of the business. In other cases, multiple individuals may be considered owners of a Y variable.

The conceptualize principal task 502 includes a third step 506 that pertains to defining the X variables that can be used to derive the selected Y variables identified in step 504. More specifically, the third step 506 includes a first substep of defining candidate X/Y relationship transfer functions. This substep involves determining one or more X variables that have a bearing on the resultant Y variables. For instance, the developers may conduct a brainstorming session to cull empirical knowledge regarding relationships between X variables and Y variables in the business, and/or may perform automated analysis to investigate such relationships. For example, the developers might determine that an X variable corresponding to worker experience level determines, in part, net income within a particular business environment. The first substep also involves defining the transform function that will translate the identified X variables into the identified Y variables. Such transfer function may present any kind of functionality for translating X variables into Y variables, including discrete mathematical equations, statistical analyses, rule-based logic, artificial intelligence systems, neural networks, etc. Again, the developers may rely on the judgment of human experts to determine appropriate transfer functions, or may resort to automated analysis to select suitable transfer functions.

Step 506 also includes another substep of exploring and evaluating data sources that can be used to supply information for the selected X variables. That is, this substep entails determining whether the business currently collects and stores information that corresponds to the identified X variables. If this data exists, this substep also determines whether the target business has access to the data for the purpose of performing predictions using a digital cockpit.

A fourth step 508 entails determining whether the model provides results that allow the business to take meaningful action (where this characteristic is referred to as the “actionability” of the model). For instance, a first substep involves defining the actionability of the X variables and Y variables that respectively represent the input and output of the model's transfer function. An X variable is actionable when it corresponds to a physical aspect of the target business that can be meaningfully controlled by the target business. That is, an actionable X variable corresponding to level of expertise of a work force is actionable, because the target business can directly manipulate this variable by hiring workers with sufficient skills, or providing necessary remedial training to existing workers. A Y variable is said to be actionable when meaningful action can be taken in response to the Y variable to affect corrective action within the target business. For instance, a predictive value that represents the level of competition may not be an actionable Y variable, since the target business does not have any way of directly controlling what its competitors do in the marketplace. Unless at least one of the variables involved in the transfer function is actionable, there is little merit to continuing with the development of the model (since the target business is not placed in a position to do anything about the predictive results generated by the model).

Step 508 also includes a substep of performing cost-benefit analysis that assesses the relative value of the predictive model. For instance, this step attempts to quantify the value conferred on the target business by performing a particular prediction, that is, by generating a particular Y variable. For instance, this assessment may entail estimating the amount of money that can be saved by using the predictive model within the target business.

Steps 502, 504, 506, and 508 provide a collection of tollgate deliverables 510. The tollgate deliverables 510 identify the exemplary results or “products” generated in steps 502, 504, 506, and 508. Such deliverables 510 include a Y selection scorecard. The Y selection scorecard provides the developers' analysis of a collection of proposed Y variables to assess the relative merits of these Y variables. The deliverables 510 also include a feasibility assessment of the X and Y variables, a multigenerational plan (MGPP) (which provides a proposed plan for developing the digital cockpit in a series of generations), and a preliminary list of candidate X variables. The deliverables 510 further include a resource list that identifies resources for use in performing the remaining principal tasks in the project. Further, the deliverables 510 may include commitments made by various individuals involved in the project—the commitments confirming these individuals' promises to devote a predetermined amount of time to the completion of the project. The deliverables 510 can further includes a cost/benefit analysis that provides the developers' analysis of costs and benefits associated with providing the digital cockpit. The deliverables 510 can further include a risk assessment that quantifies the risks involved with continuing with the project and developing the predictive model for integration into the digital cockpit.

A final deliverable provided in the collection of deliverables 510 includes the approval of the steering commitment. Namely, the steering commitment monitors the progress of the development effort throughout the first task 402. More specifically, the steering committee determines whether the developers have completed the specified steps and substeps in the process 400 to deliver the specified deliverables 510. The steering committee also determines whether the deliverables 510 are satisfactory. If so, the steering committee authorizes the developers to continue with the next principal task 404 (Acquire/Assess). If the steering committee is not satisfied with the course of the conceptualize principal task 402, then the steering committee may instruct the developers to repeat one or more steps or substeps within the principal task 402, or if the assessed deficiencies are deemed irresolvable, terminate the development project.

B.1(c). The Second Principal Task: Acquire and Assess

The Acquire/Assess principal task 404 includes a first step 602 of acquiring and assessing data. This step 602 generally involves examining the data that will be used as input to the model to make sure that it can be used to generate predictive results. More specifically, this step 602 involves a first substep of finalizing the candidate X variable selection. This entails reviewing the analysis performed in the first principal task 402, and, based on this analysis, identifying a final set of X variables to be used as input to the predictive model.

Step 602 includes another substep of assessing the quality of the data that will define the X variables. This substep entails examining the data to determine whether it can be acquired in other words, whether the target business actually has the data that is claims it has (as opposed to, for instance, this data having been deleted). This substep also involves determining whether the data can be satisfactory “cleaned” and “validated.” “Cleaning” generally refers to transforming the data into an adequate format for processing by the predictive model, e.g., by arranging the data in a specified manner, removing extraneous fields, adding missing fields, etc. “Validating” refers to ensuring that that the data is sufficiently accurate for processing by the predictive model, or can be transformed into a sufficiently accurate form.

Step 602 includes another substep of making an overall judgment whether the data analyzed in the proceeding substep will support the use of a predictive model in a digital cockpit—that is, whether the data is available and is of sufficiently high quality to use in a digital cockpit. The process 400 does not always pass this step. This is because the data that has been acquired and stored in the normal course of operation of the target business may not have been collected with the intent of providing business predictions using a digital cockpit. Hence, while this data is sufficient for whatever purpose it was originally collected (e.g., for tax purposes, etc.), it may be insufficient to support predictions using the digital cockpit.

Step 602 involves a final substep of performing data analysis. This substep involves performing more fine-grained analysis on the data to determine its characteristics.

The conceptualize principal task 402 includes a second step 604 of measuring the predictive potential of the data identified in the preceding substep. The step 604 includes a first substep of data mining. Data mining refers to performing analysis on the data to determine its characteristics. This substep provides insight into the interrelationships between different data fields (e.g., whether different data fields are correlated, etc.).

The step 604 includes another substep of creating a prototype model. A prototype model refers to an experimental version of the model, where the model performs the function of mapping the selected X variables into the Y variables. The developers may design this prototype model by modifying an existing model currently running within the digital cockpit. Alternatively, the developers may provide this prototype model by designing such model “from scratch.” At this point in the process 400, the prototype model typically exists in an abstract form (e.g., as a mathematical equation, or algorithm), rather than fully implemented program code. That is, the emphasis at this point in the process is to work out the general design features of the analytical technique that will transform the X variables into the Y variables, not to finalize a working version of the model.

Step 604 includes another substep of assessing the explanatory power verses the predictive power of the prototype model. This substep attempts to determine the nature of the nexus (if any) between the identified X and Y variables, and, more particularly, to determine whether the relationship between the X and Y variables represents an “explanatory” link or a “predictive” link. An explanatory link reflects a superficial finding that the presence of certain X variables is accompanied by the presence of certain Y variables. This finding helps describe the relationship between the X and Y variables, and thus has descriptive merit. However, this finding does not necessarily suggest that there is predictive nexus between the X and Y variables. More specifically, the observed association between the X and Y variables may be incidental, reflecting some other behavior in the target business that is not fully understood by the developers. On the other hand, a predictive nexus would suggest that the X variables are “drivers” of the identified Y variables, such that a change in an X variable necessarily produces a predictable lockstep change in a Y variable. The developers, of course, strive to provide models that have predictive power. In performing the analysis in this substep, the developers may validate the predictive nature of the model using a different set of data than what was used to develop the model, to better ensure that the model does indeed possess the capacity to predict Y variables based on X variables.

Step 604 also involves assessing potential application constraints in developing and using the model. For instance, the developers may discover that the business has maintained data for one regional division, but not another regional division. Or the developers may find that the business has maintained data for the last five years, but, for some, reason, cannot provide data for one quarter in that time period. The developers will accordingly take these types of constraints into consideration in the subsequent development steps, either by rectifying the identified deficiencies, or by simply making note of these deficiencies and their probable impact on the utility of the digital cockpit.

Step 604 terminates in another feasibility tollgate. This tollgate requires the developers to conclude, based on the foregoing analysis, whether the prototype model provides sufficient predictive power to warrant continuing with the development effort. For instance, if the association between the X and Y variables is merely superficial and incidental—that is, not reflecting any direct predictive nexus—then the developers will decide to abandon the project, or repeat parts of the above-described development project, e.g., by selecting different associations of X and Y variables, and so on. In other cases, the developers will determine that the model has some predictive power, but that this predictive power is not 100 percent reliable (which will typically be the case). In this case, the developers may provide the target business with some idea of the projected accuracy of the digital cockpit under development (e.g., by specifying that the model will provide accurate results 80% of the time). The target business will respond by letting the developers know whether the stated accuracy is sufficient for their needs, or whether the developers needs to make changes to provide greater accuracy (or abandon the project if greater accuracy cannot be obtained).

The acquire/assess task 404 includes a third step 606 that includes planning aspects of the presentation to be provided by the digital cockpit interface, and also planning the end-user functionality (usability) to be provided by the digital cockpit. More specifically, “presentation” refers to the way information is organized and laid out on the digital cockpit interface. For instance, the target business may specify that they want predictive results to be presented on a quarterly basis, annual basis, etc. The target business may also specify that they want the digital cockpit interface to provide certain “what if” input mechanisms, or a certain organization of interface pages, etc. “Usability” refers to the manner in which the end-users in the target business intend to use the digital cockpit, which determines the functionality that must be provided to the end-users.

More specifically, step 606 includes a first substep of developing “use cases.” The use cases define different functions that will be performed by the digital cockpit under development, that is, from the perspective of an end user.

The step 606 also involves generating a storyboard. A storyboard describes the development and manner of using the digital cockpit using a sequence of multiple panels, which collectively form a narrative or “story.” Formulation of a storyboard helps the developers communicate their ideas to others who require a high-level and intuitive understanding of the project. The formulation of the storyboards also helps the developers clarify their own ideas regarding the project.

Steps 602, 604, and 606 provide a collection a tollgate deliverables 608. Such deliverables 608 include an assessment of data quality, an operating action plan (which defines how the target business intends to use the digital cockpit), a collection of analyzed X variables, descriptive analysis of data (which assesses the characteristics of the data), one or more storyboards, Commercial Off the Shelf (COTS) tools identification (referring to an identification of tools that can be purchased “off the shelf” from commercial sources, rather than custom built), etc. A final deliverable included in the collection of tollgate deliverables 608 includes the approval of the steering commitment. As mentioned above, the steering committee determines whether the evolving project has passed all of the milestones set forth in the first two principal tasks. If this is not the case, the steering committee may instruct the developers to repeat one or more of the above-described steps, or may decide to abandon the project.

B.1(d). The Third Principal Task: Model

Whereas the previous principal task (acquire/assess 404) involved designing a prototype of the model, the third principal task 606 involves building the actual model that will be used to govern the operation of the digital cockpit. More specifically, the third principal task 406 includes a first step 702 of developing and validating the model. This step 702, in turn, includes a substep of developing a final model. This substep involves refining the prototype model developed in the preceding task (404) to provide a final working model.

The step 702 involves another substep of validating the final model. Validation may include forming predictions using the final model using data that the model has not “seen” before (as opposed to data used to design the model), to thereby determine whether the model truly provides reliable predictions.

The step 702 involves another substep of analyzing application constraints associated with the finalized model. An application constraint may refer to certain functions that that the digital cockpit will not be able to perform, because, for instance, it lacks data for certain periods of time, or for certain parts of the business, etc.

Finally, step 702 involves again determining whether the digital cockpit remains feasible based on the foregoing analysis. If not, the developers may seek to repeat one or more of the foregoing substeps in the process 400 using different assumptions, etc.

The model task 606 includes a second step 704 of developing an implementation plan for the digital cockpit being designed. This step 704 involves a substep of scripting the data extraction, transformation, and model execution steps. The extraction and transformation steps pertain to the manner in which the digital cockpit will acquire the data and transform it into a desired format. The model execution step refers to the operations involved in actually processing the acquired and transformed data using the predictive model. “Scripting” refers to the generation of instructions that set forth the sequence of operations involved in extracting, transforming, and processing the data with the predictive model.

Steps 702 and 704 provide a collection of deliverables 706. Such deliverables 706 includes the final validated model. The deliverables 706 also include the script that describes the sequence of operations involved in extracting, transforming, and processing the data in the predictive model. Finally, the deliverables 706 also includes approval by the steering committee, which determines whether the development project is thus far proceeding on track.

B.1(e). The Fourth Principal Task: Implement

The fourth principal task 408 involves actually implementing the digital cockpit designed in the preceding principal tasks. Within this principal task 408, a first step 802 involves implementing the model. This step 802, in turn, involves building the model in whatever particular program code package and technical infrastructure (e.g., “runtime system”) is deemed appropriate. For instance, the target business may have an existing digital cockpit system architecture on which the model being developed will run. Further, the developers may opt to develop the model using one or more analytical tools, such as SAS, Mathematica, etc. These systems and program tools used to implement the model define the runtime system.

The implement principal task 408 includes another step 804 that involves assuring that the model is producing results of sufficient quality. This step 804 involves a first substep of testing and debugging the model on a test platform. A test platform refers to a trial system used to implement the model, which is separate from the infrastructure used by the business on a day to day basis. By testing the model on the test platform, the developers can resolve the errors in the model without impacting the business operation.

Step 804 also includes another substep of validating the model's performance in the test platform to ensure that it is producing the kind of results that were projected based on the prototype model developed in earlier principal tasks in the process 400.

The implement principal task 408 includes a third step 806 that involves implementing the presentation aspects of the digital cockpit. This step 806 includes a first substep of designing web pages that implement the storyboard developed in the model principal task 406. That is, the previously developed storyboard sets forth a sequence of cockpit interface presentations that the user will receive in the course of using the digital cockpit. The first substep in the step 806 actually designs the web pages that will fulfill the plan outlined in that storyboard.

Step 806 includes a second substep of performing preliminary usability testing on the interface presentation developed in the preceding substep. Usability testing entails using the digital cockpit to determine whether it provides the desired functionality specified in previous principal tasks. If the testing indicates that the digital cockpit is deficient in any way, the developers can modify the interface presentation. More specifically, the developers can repeatedly perform usability testing followed by making appropriate modifications to the digital cockpit. Through this procedure, the digital cockpit should move progressively closer to a desired state.

The implementation principal task 408 includes a fourth step 808 of actually installing the model. This step 808 entails installing the model on the production platform. The production platform refers to the infrastructure on which the target business will use the digital cockpit on a day to day basis.

Steps 802, 804, 806, and 808 provide a collection of deliverables 810. These deliverables 810 include the actual model as implemented in a development system. The deliverables 810 further include a preliminary usability testing report and a final usability testing report (providing the results of usability testing at different points in the development process of task 408). The deliverables 810 further include a usability follow-up plan or mechanism, which provides a strategy for continued testing of the functional attributes of the digital cockpit, and/or plans for rectifying problems detected during the usability testing. The deliverables also include a maintenance plan for the program code used to provide the model, as well as a maintenance plan for the model itself. A maintenance plan specifies the manner in which the developers plan to maintain different aspects of the model after its integration into the digital cockpit. That is, the target business and/or marketplace may change over time, making the predictions provided by the models less accurate. A maintenance plan provides a strategy for revisiting the accuracy of the model at scheduled times in the future to ensure that the model remains on track and providing accurate results. The deliverables 810 further include a transition/roll-out plan that specifies a strategy for introducing the digital cockpit including the new model to the users in the target business. Finally, the deliverables 810 include an approval by the steering committee. The approval determines whether the project continues to proceed on track, e.g., by providing satisfactory deliverables at specified times.

B.1(f): The Fifth Principal Task: Transition

The last principal task, transition 410, pertains to the integration of the model into the digital cockpit of the target business and subsequent monitoring activities to ensure that the model is providing useful results. More specifically, the transition principal task 410 includes a first step 902 of finalizing the integration of the model into system infrastructure provided by the target business. More specifically, step 902 includes integrating the model into the digital cockpit used by the target business, and a second substep of performing final usability testing on the integrated model.

The transition principal task 410 includes a second step 904 of monitoring the model. This step 904 includes a substep of providing ongoing monitoring, validation, and tuning of model parameters to ensure that the model continues to provide accurate predictive results for the target business. The accuracy of the model can be gauged using a “goodness of fit” measure. The goodness of fit reflects the difference between the predictions generated by the model and what actually later happens in the target business. This goodness of fit measurement can be expressed as a percentage, e.g., where a percentage of 100% reflects a completely accurate prediction. The developers can compare the goodness of fit measurement with a threshold value (say, for example, 80%). The developers can specify that corrective action should be taken when the goodness of fit measurement falls below the predetermined threshold value. The target business can respond to this event by adjusting the operating parameters of the model to restore the goodness of fit measurement to an acceptable level.

The transition principal task 410 includes a third step 906 of monitoring the benefits provided by the system. This step 906 includes a first substep of measuring the benefits conferred on the target business by the model, and also the costs associated with the model. Further, step 906 includes another substep of providing ongoing user assessment of the benefits provided by the model. This may entail conducting a series of follow-up focus groups to explore the model's value in view of changing circumstances in the target business and in the marketplace.

Steps 902, 904, and 906 terminate in tollgate deliverables 908. These tollgate deliverables 908 include a validation of cost-benefit analysis. The deliverables 908 also include an assessment of goodness of fit over time (which assesses the continued capacity of the model to provide accurate results as time progresses). The deliverables 908 can also include an assessment of future model capabilities based on an operating action plan. This assessment attempts to determine whether the model will continue to provide valuable results based on the direction that target business appears to be moving in, as well as other factors that have a bearing on the future course of the target business. This assessment can also project future enhancements to the model based on anticipated developments within the business. The deliverables 908 also include a “post-mortem” assessment of the new model. This refers to a user assessment of the model some period of time after its initial integration into the digital cockpit (e.g., a new months after its integration). Finally, the deliverables 908 include an approval by the steering committee, which determines whether the project has met its intended objectives and deliverables.

B.2. Exemplary Tools for Use in Carrying out the Process

A suite of tools can be used to facilitate execution of the above-identified process 400. In one case, these tools can include worksheets that provide guidelines used to perform respective substeps in the process 400. In another case, the tools can include automated techniques for providing a recommendation based on a number of input considerations. Still other types of tools can be employed to assist the developers in performing selected substeps in the process 400. This section of the disclosure discusses one exemplary and non-limiting set of tools.

A cockpit roles tool comprises a worksheet that identifies the roles of the participants in the development project. This worksheet can comprise a leftmost column that identifies the names of different roles associated with the project. The next column provides a description of the role names. For instance, in one exemplary implementation, the worksheet can identify the following roles associated with the business steering committee: a) the business champion senior leadership team (SLT), whose function it is to drive project “vision” (e.g., project objectives); b) business project lead, whose function it is to facilitate project tasks; c) representatives of the SLT team, whose function it is to influence “Y” selection; d) e-business leader (digitization leader), whose function it is to ensure adherence with digitization efforts; e) owners of candidate/actual Y variables, whose function it is to report on the measurability and suitability of the Y variables; f) quality lead/advanced analysts, whose function it is to guide the analytical approach used in the project; and g) business data leaders (data warehouse leads), whose function it is to advise on data availability and quality, etc. The worksheet can identify the following roles associated with business resources: a) owners of candidate/actual X variables, whose function it is to report on data availability and quality; and b) user group representatives, whose function it is to represent usability requirements, etc. The worksheet can also identify the following roles associated with so-called facilitators: a) workout facilitator, whose function it is to drive best practices, etc. The worksheet can identify the following roles associated with the implementation team: a) project lead, whose function it is to lead the implementation efforts, ensure quality, and supervise the compilation of the storyboards; b) statistician and/or econometrician, whose function it is to guide the analytical approach; c) analytical engine programmer, whose function it to implement the model in an engine of choice (e.g., SAS, Mathematica, etc.); d) ETL programmer, whose function it is to support data quality and implement ETL routines; and e) presentation/digital cockpit developer, whose function it is to implement presentation of predictive metrics. The worksheet can also identify the following roles associated with business information technology (IT) support: a) IT data lead, whose function it is to ensure accessibility and availability of data; b) IT digital cockpit lead, whose function it is to integrate the presentation; and c) IT transition/support lead, whose function it is to lead transition of the technology. The worksheet also identifies the following roles associated with business analytics support: a) statistician and/or econometrician support leader, whose role it is to maintain the model and monitor goodness of fit over time. Finally, the worksheet can also identify the following roles associated with ongoing maintenance: a) IT transition/support lead, whose function it is to address any concerns or problems that may arise following integration of the developed model (of an IT-related nature); and b) statistician support lead, whose function is likewise to address any concerns or problems that may arise following integration of the developed model (of a statistical nature).

The cockpit roles worksheet also includes a series of columns that specify an estimate of the amount of time that each of the above-identified job responsibilities is expected to take. For instance, the amount of time can be specified as a percentage level, indicating the percentage of a participant's time that will be demanded to perform the specified responsibility. More specifically, this time estimate can be specified for each principal task in the process. In this manner, a participant in the project is alerted to the amount of time resources required by the development project in its different stages, and thus can provide a more accurate indication of his or her ability to meet such responsibilities.

Another tool is a duration estimate worksheet. The duration estimate worksheet identifies, in a leftmost column, the principal tasks in the process 400, namely, conceptualize, acquire/assess (involving subtasks of measuring data, measuring predictive potential of the model, and performing steps relating to presentation and usability), model, implement, and transition. Another column provides values that estimate the amount of time required to complete each of the tasks specified in the leftmost column. Another series of columns identifies a span of time comprising several weeks, where each column is associated with one week in this time span. This calendar display allows the developers to show the allocation of different tasks to corresponding time periods in the manner of a Gantt chart (e.g., by using time bars that span one or more columns in the calendar display, etc.).

Another tool is a risk worksheet. The risk worksheet alerts the developers to common risks involved in the development project. In exemplary business environment, an exemplary list of risks can include: a) lack of adequate historical data and/or poor data quality (e.g., because data does not effectively represent the population for which prediction is being performed, or because there is a lack of understanding of the data's origin or meaning, or because the operational data sources change in meaning over time, or because the data sources do not effectively measure the business condition they intend to measure, etc.); b) the model refutes current business beliefs; c) the identified Y variable is not feasible (e.g., because the selected Y variable is not feasible to predict, which may reflect the fact that there is a mismatch between the Y variable and the available X variables); d) lack of understanding of adverse effects concerning actionability (e.g., because the business does not consider the complex relationships that exist between metrics, or because a change in one business metric has an unexpected adverse effect on another business metric); e) lack of business buy-in and project ownership (e.g., due to the failure to designate a business “champion,” or the failure to secure a long-term business commitment); f) underestimation of the time and expense required to build predictive models (e.g., because the predictive models are difficult to build because of their complexity, and/or require effective long-term maintenance); g) predictive results are not repeatable (e.g., because of lack of consistency in data acquisition operations, lack of consistency in processes that drive the underlying data, lack of consistency in the environment in which the model is used, or lack of understanding of relationship between model effectiveness and the data upon which the model was built, etc.); h) lack of model maintenance or lack of on-going analytics quality control (e.g., because there is no effective planning maintenance operations, which causes the model to become unreliable over time, or because models have been selected that are not feasible to maintain, or because there are too many models to maintain, or because maintenance requires too high a level of expertise to maintain, or because there is a failure to update the model when expected business conditions or environment changes, or because of unforeseen changes in business structure, environment, or underlying data causes a decrease in model effectiveness, etc.); i) the model is used outside of the design constraints (e.g., due to the use of the model under differing business conditions than it was originally built for, or due to the use of the model to predict a different population than it was originally built for); j) intangible and/or unquantifiable business benefits (e.g., reflecting benefits of predictive modeling that cannot be readily quantified, and thus, cannot be readily used in performing cost-benefit analysis). Still other risks can be specified in the risk worksheet depending on the characteristics of a specific business environment.

Another tool is a Y-selection scorecard. This scorecard is used to help the developers identify viable Y variables that should be modeled in a predictive model. To that end, in a leftmost column, the Y-selection scorecard identifies a number of desirable properties that a Y variable should have to warrant building a model to predict the Y variable. For instance, such properties can include: a) there is a real business problem requiring solution (indicating that the Y variable can be used to address an actual problem within the business); b) prediction results are actionable; c) predictability of Y would have conceptual return on investment (ROI); d) Y variable data can be obtained from external or internal data sources; e) data is accessible and usable; f) the Y variable is a driver of net income for the business; g) the information associated with the Y variable is reviewed routinely; h) the key drivers associated with the Y variable are clearly understood; i) the candidate set of X variables exists and can be obtained from internal or external data sources; j) the candidate Y variable captures customer critical to quality (CTQ) objectives, etc. Another column in the worksheet assigns a weighting score to each of the above-identified properties. For instance, the weighting score can range from 1 to 10, where 10 indicates a highly relevant property. To assess the relative merit of a candidate Y variable, the developers use the worksheet to record whether the candidate Y variable possesses each of the above-identified properties. The developer then adds up the weighting scores recorded for the candidate Y variable to provide a total score for the candidate Y variable. The desirability of a collection of candidate Y variables can be assessed by comparing their respective total scores, the highest total score corresponding to the most desirable candidate Y variable.

Another tool provides a worksheet that helps the developer validate X variables. This worksheet has a similar structure to the Y-selection scorecard discussed above. Namely, the leftmost column provides a list of properties that an X variable should possess to be included as a driver of the model. Exemplary properties include: a) the business is authorized to access the data associated with the X variable; b) the data can be cleaned without the system missing data; c) the data clearly represents what it purports to measure; d) the data is consistently measured in both scale and time; e) the X variable is intuitively important to the business; f) there is a low occurrence of missing and/or artificial (made-up) data; g) the data is retained as historical data in the business; h) the X variable is actionable; i) the data is currently available in digitized form; j) the data is refreshed at appropriate granularity; and k) the data has a single owner, etc. Again, a weighting score can be associated with each of these properties. The developer generates a total score for a candidate X variable in the manner described above for the Y-selection scorecard. The total scores associated with a plurality of candidate X variables provide guidance on what X variables should be included in the model under development. That is, a developer will be more likely to select an X variable that has a relatively high total score.

Another tool provides guidelines for handling censored data. That is, a business will often provide an incomplete record of its operations, such that data is missing for certain spans of time, or for certain aspects of the business. This may be attributed to a failure to collect data regarding an event that has already happened, or the inability to collect data from an event that is yet to happen. For instance, consider the case where a model is being developed to predict when a customer will return a leased asset. Presume that the business is relatively young, and therefore does not have a lengthy history of pick-up and return times for its inventory of assets (such as a fleet of vehicles for rental). In this case, the data that the business does have may reflect only those cases where customers have returned assets early. Thus, if a prediction was formed on the basis of this data alone, the model might provided a skewed notion of how long the average customer takes to return an asset (e.g., by providing a cycle time estimate that is unduly short). This is because the customers that are apt to return their assets later have not been factored into the analysis. A worksheet for pointing this phenomenon out to the user may consist of a timeline that graphically illustrates the time at which data was collected, and thus also illustrates gaps in the collected data. This worksheet thus helps convey the impact that missing data might have on predictions formed from such data. Using this worksheet, the developers can take the effect of the missing data into account when they construct the model.

Yet another tool can provide a worksheet used to assess causality between X variables and Y variables. This worksheet identifies a number of factors to consider when assessing causality. For instance, as to the issue of correlation, the worksheet prompts the developer to consider whether there is a statistically significant relationship between an X variable and a Y variable (that is, the relationship is not random). As to the issue of causation, the worksheet prompts the developer to consider whether the X variable causes the Y variable. As to the issue of consequence, the worksheet prompts the developer to consider whether the Y variable causes the X variable. As to the issue of coincidence, the worksheet prompts the developer to consider whether a Z value causes the X variable and the Y variable, but the X variable and the Y variable are not otherwise related.

Another tool provides a worksheet that identifies guidelines in performing data acquisition and data validation. These guidelines can specify the following suggested exemplary actions or considerations: a) establish a data set representative of the population that is being predicted; b) establish a repeatable, consistent process for acquiring data sets used for modeling; c) identify measurable and reliable X variables and Y variables; d) acquire data for a long enough window to perform prediction; e) obtain updated real-time and in-sync data (e.g., captured at consistent time intervals); f) identify the presence of reliable unique identifiers in the data; g) create a comprehensive data dictionary for all data systems; and h) validate data using subject matter experts for better understanding of the data and business problem associated with the prediction. This last action may include the following actions: h1) perform exploratory analysis of candidate X variables and Y variables by performing descriptive statistics; h2) capture business formulation of potential drivers and interactions; and h3) establish relationships between drivers by performing confirmatory analyses.

Another tool provides a worksheet that identifies guidelines in performing effective modeling. These guidelines can specify the following exemplary actions or considerations: a) if necessary, in addition to modeling the entire population, define cohesive subsets of data within the business, and perform modeling on those subsets; b) identify the actionable X variables (causal relationships verses associations) and define the valid range suitable for “what if” scenarios for each actionable X (or combination of X variables); c) consider redefining the X variables and Y variables to make them more powerful in the analysis (e.g., by making continuous variables categorical and/or performing cluster-factor-discriminant function analyses); d) if necessary, model intermediary Y variables as potential X variables for a principal (big) Y variable; e) create dynamic models rather than static ones in which the parameter estimates are fixed, etc.

Another tool provides a worksheet that identifies best practices regarding the topic of analytics within operational systems. A best practice identifies a strategy that has consistently proven to yield desirable results. These guidelines can specify the following exemplary actions or considerations: a) predetermine X variables that can be predictors and collect comprehensive data on these X variables; b) determine Y variables of interest; c) avoid systematic missing data; d) formulate analytical approach in conjunction with the business; e) track history on X variables to ensure proper historical frame of reference; f) establish “grain” needed to support drill down and aggregation, etc.

Another tool provides a worksheet that identifies a collection of Do's and Don'ts to assist the developer in identifying actions that have proven to yield favorable results in the business, while avoiding other actions that have shown to lead to unfavorable results. Exemplary Do's include: a) do recognize that it will take longer to perform steps than might be anticipated; b) do provide feedback on data cleaning results to transactional systems; c) do involve existing analytics team members in the project to leverage business analytics expertise; d) do document and archive all model development and modeling results to provide an audit trail of data characteristics observed and actions taken as well as validation sets for implementation testing; e) do create intermediate predictive models when there are many drivers for a Y variable; f) do ensure that the business owner is the “user” of the Y variable, etc. Exemplary don'ts include: a) don't assume all your data is of adequate quality; b) don't short-circuit the data assessment operations obtain the data as soon as possible; c) don't think that there is one person that is knowledgeable concerning the entire data; d) don't assume that the rigor that is placed on the data in operational systems will guarantee the quality standards required for analytics, etc.

Another tool provides a worksheet that identifies best practices regarding the topic of transition planning. These guidelines can specify the following exemplary actions or considerations: a) identify transition team by identifying team members suitable to take ownership of the analytics portion of the project, and identify team members suitable to take ownership of the IT portion; b) identify hardware/software requirements, review existing hardware/software availability for suitability, and purchase hardware/software as needed; c) establish transition schedule, lead team members, and milestones; d) identify networking and security issues; e) request any necessary approvals, and establish access to required data stores; f) review all model and system documentation prior to transition, and schedule discussion sessions throughout transition period between development and maintenance team to ensure effective knowledge transfer; g) configure hardware, install and configure software, configure databases; i) establish database connectivity, test and validate models and system installation, etc.; j) establish test and production systems to ensure effective quality control, and establish code/model control procedures via a source code control system, etc.

Still additional tools can be provided to assist the developers in performing the process 400.

B.3. Exemplary Implementation of the Development Technique

The process 400 described in FIG. 4 can be executed in different ways. In one case, information regarding the process 400 and its associated collection of tools is manually distributed to participants in the project. The participants then set forth carrying out the tasks, steps, and substeps specified in the process 400, using appropriate tools at appropriate junctures in the process 400. To facilitate discussion, the information regarding the process tasks and associated steps and substeps will hereinafter be referred to as a “process roadmap.”

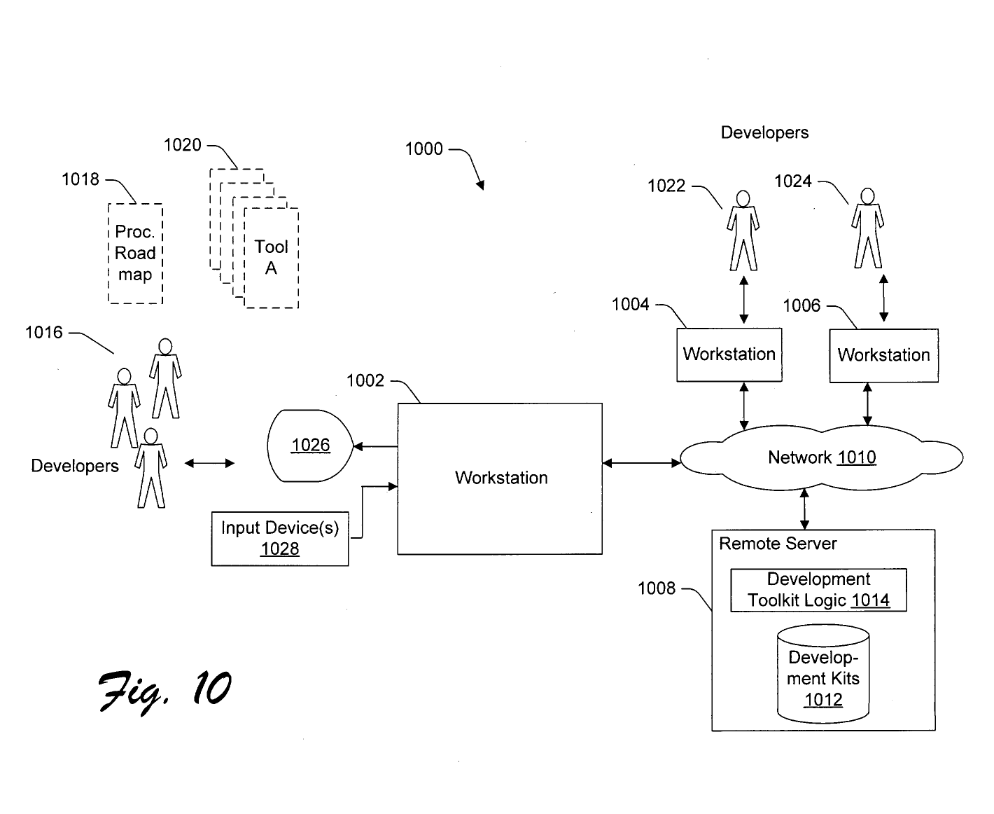

Alternatively, aspects of the above-described process can be automated. For instance, consider the exemplary system 1000 shown in FIG. 10. The system 1000 includes a plurality of workstations 1002, 1004, and 1006 coupled to a remote server 1008 via a network 1010. A remote server 1008 includes a database 1012 that contains information used to carry out the process 400, such as the process roadmap and associated tools. The remote server 1008 also provides development toolkit logic 1014. This logic 1014 includes program code that enables a developer to interface with the information provided in the database 1012. For instance, the logic 1014 can include program code that defines a plurality of interface pages that can be presented at a workstation (1002, 1004, 1006). The interface pages provide information retrieved from the database 1012. In this manner, for instance, a group of developers (e.g., developers 1016) can retrieve a process roadmap 1018 and associated tools 1020 from the remote sever 1008 via appropriately configured interface pages presented by the workstation 1002. Other developers (e.g., developers 1022, 1024) can retrieve the same information at other respective workstations (e.g., workstations 1004, 1006).

The workstations (1002, 1004, 1006) can include conventional hardware, such as the hardware illustrated and discussed with reference to workstation 246 in FIG. 2. Further, the workstations (1002, 1004, 1006) can interface with the developers (1016, 1022, 1024) using conventional input and output devices, such as, in the case of workstation 1002, display device 1026 (or more generally, an output device), and input device 1028. The network 1010 can comprise any type of hardwired and/or wireless network, such as the Internet, an intranet, a LAN, etc.

In an alternative implementation, the development toolkit logic 1014 and database 1012 can be located locally within each individual workstation (e.g., workstations 1002, 1004, 1006). In this case, the system 1000 would not require the use of the remote server 1008.

In still another implementation, referring back momentarily to FIG. 2, the control module 132 of the digital cockpit 104 can itself include development toolkit logic and an associated database. These features are shown in FIG. 2 as development toolkits logic 242 and associated database 244. Accordingly, in this implementation, the digital cockpit 104 itself includes a development interface that provides guidance on adding models to the model database 232, or modifying models already stored in database 232. Alternatively, the development toolkits logic 242 and associated database 244 can be used to develop a model for another division's or company's digital cockpit. In this latter implementation, the digital cockpit can thus be used as a launching platform to spread digital cockpit technology to other businesses or once it is implemented with one or more base businesses.

Still other strategies are possible and are envisioned for assisting the developers in carrying out the operations specified in the process roadmap.

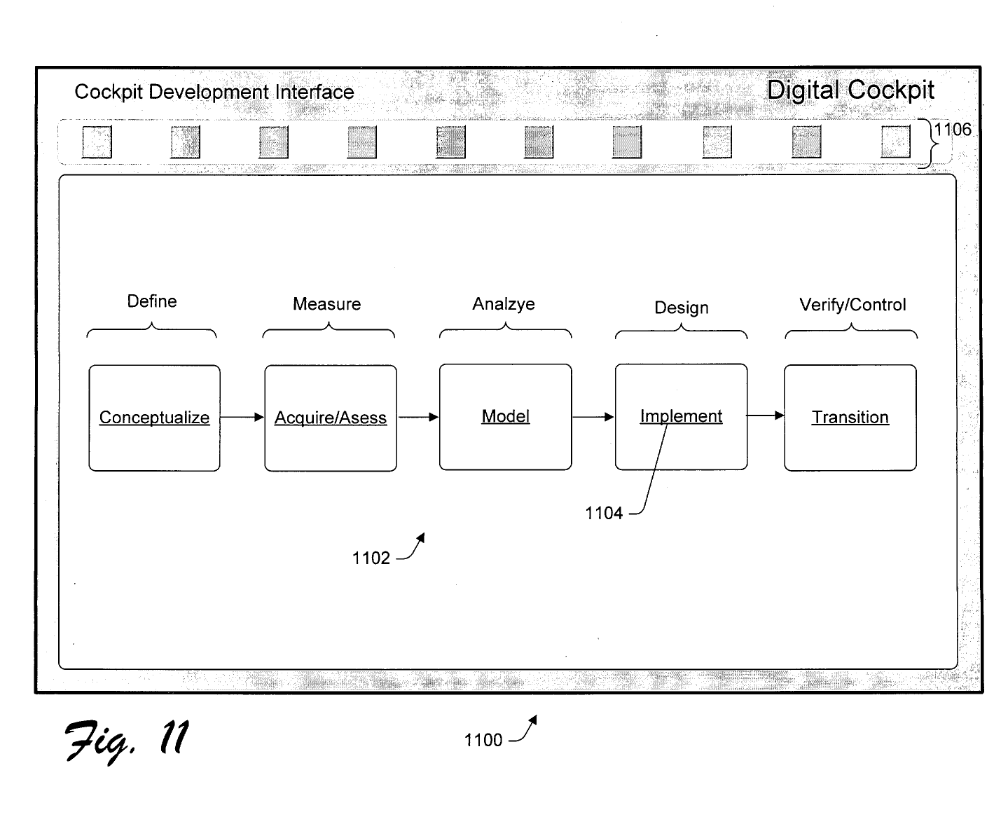

FIG. 11 shows an exemplary main interface page 1100 that can be presented on a workstation (e.g., any one of the workstations 1002, 1004, 1006) using the system 1000 shown in FIG. 10. This main interface page 1100 includes a main section 1002 that provides a graphical representation of the principal tasks in the process 400, that is, a conceptualize task, acquire/assess task, model task, implement task, and transition task. Hypertext links can be associated with the text shown in the graphical rendering of the process 400. Activation of these links (e.g., by pointing to and clicking on these links with a mouse pointing device, or other device) prompts the system 1000 to provide additional information regarding the activated link in one or more additional interface pages. Such additional information can include a definition of the activated principal task. Alternatively, although not shown, clicking on a hypertext link associated with a principal task can prompt the system 1000 to provide another interface page that lists the steps and substeps associated with the activated principal task. Text within this other interface page can also include hypertext links. Activation of these links can prompt the system 1000 to retrieve and display information regarding the steps and substeps associated with the activated hypertext links, or can prompt the system 1000 to provide one or more tools associated with the activated hypertext links. For instance, if a developer was performing the step associated with the selection of Y variables, activation of the hypertext-linked text associated with this substep would prompt the system 1000 to retrieve and display an interface page containing the Y-selection scorecard.

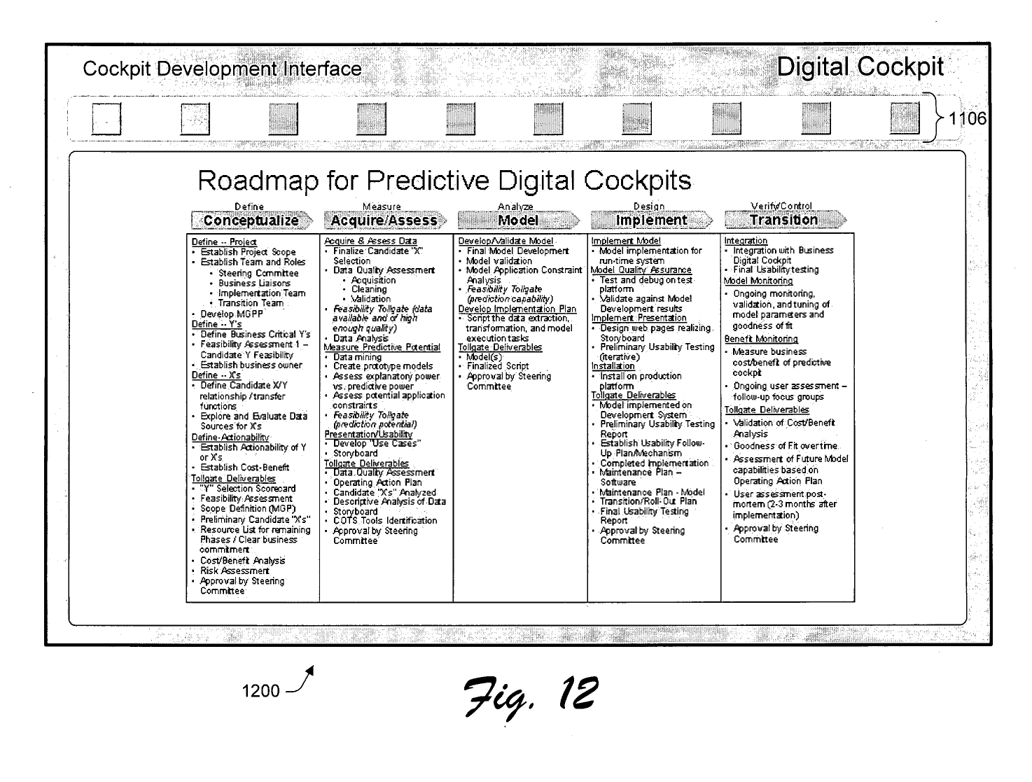

FIG. 12 shows an alternative main interface page 1200 for providing information regarding the overall process 400, e.g., by presenting all of the principal tasks, steps, and substeps on a single display page. Although not shown, this interface page 1200 can include a graphical mechanism for indicating the developers' level of completion with a process. This can be conveyed by using a thermometer graphical progress meter that indicates how far the developers have advanced in the process by noting progress level on the thermometer. That is, each column (or “swim lane”) associated with a principal task can include a vertically disposed thermometer that indicates progress within the principal task.

Both interface pages 1100 and 1200 shown in FIGS. 11 and 12, respectively, include a collection of graphical buttons in field 1106. These graphical buttons can be configured to activate a variety of information and/or functionality regarding the process 400. For instance, a collection of the buttons 1106 can be assigned to different respective tools. Clicking on one of these buttons can thus prompt the system 1000 to retrieve and display a tool that provides assistance in completing a substep within the process 400. Other graphical buttons in field 1106 can initiate other actions, such as the retrieval of information from a database, storage of information in a database, sending an email to a fellow-developer regarding the development project, etc.

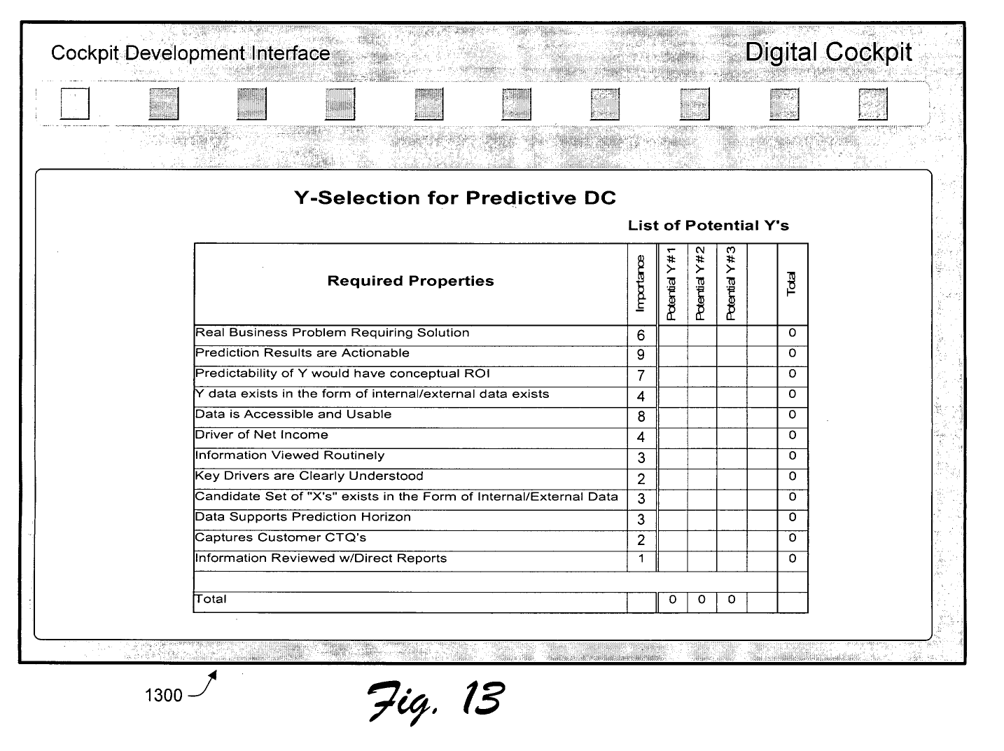

FIG. 13 shows an exemplary interface page 1300 that provides a tool used to assist the developer in performing a substep. In this case, the interface page 1300 provides the Y-Selection tool discussed above in Section B.2. Other interface pages can be provided to display other tools.

C. Conclusion

A process for developing a model and integrating the model into a business intelligence system of a business has been described, along with an associated method and system of carrying out the process. The process allows for the efficient development of models.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A process for developing a model and integrating the model into a business intelligence system of a business, comprising:
defining at least one variable X to serve as an input to the model and at least one output variable Y to serve as an output of the model;
assessing whether there is sufficient data of sufficient quality to operate the model in the business intelligence system of the business, and creating a prototype design of the model;
further developing the prototype design of the model to produce a final model design, and validating output results provided by the final model design;
implementing the final model design to produce an implemented model, and developing an interface that enables a user to interact with the implemented model; and
integrating the implemented model and associated interface into the business intelligence system to provide an integrated model, and repetitively monitoring the accuracy of output results provided by the integrated model.

2. A process according to claim 1, wherein the integrated model predicts a business metric that reflects one aspect of the business's performance.

3. A process according to claim 1, wherein the integrated model receives at least one input variable X, and based thereon, generates the at least one output variable Y using a transfer function, where the output variable Y represents a predicted business metric based on the at least one input variable X.

4. A process according to claim 1, wherein:
the defining is performed in a first principal task of the process;
the assessing is performed in a second principal task of the process;
the developing is performed in a third principal task of the process;
the implementing is performed in a fourth principal task of the process; and
the integrating is performed in a fifth principal task of the process.

5. A process according to claim 4, wherein the first principal task of the process further comprises defining the scope of the process, the scope defining objectives which the process is intended to accomplish.

6. A process according to claim 4, wherein the first principal task of the process further comprises defining roles for a collection of participants in the process.

7. A process according to claim 6, wherein the defining of the roles comprises defining one or more individuals that will act as a steering committee, the steering committee performing the function of directing a flow of operations in the process and assessing whether a series of tollgate requirements have been met at respective points in the process.

8. A process according to claim 4, wherein the first principal task of the process further comprises determining whether the at least one X variable is actionable, wherein an actionable variable represents a metric that the business can manipulate.

9. A process according to claim 4, wherein the second principal task of the process further comprises assessing the predictive capabilities of the prototype design of the model.

10. A process according to claim 4, wherein the third principal task of the process further comprises determining whether there are any constraints on the functionality provided by the final model design.

11. A process according to claim 4, wherein the fourth principal task of the process further comprises testing and debugging the implemented model.

12. A process according to claim 4, wherein the fifth principal task of the process further comprises monitoring the benefits provided by the integrated model to ensure that the integrated model continues to serve a useful role in the business.

13. A process according to claim 4, further comprising accessing and using at least one tool to facilitate performance of at least one of the first through fifth principal tasks.

14. A process according to claim 13, wherein the at least one tool comprises a worksheet that provides a guideline for performing analysis in connection with at least one of the first through fifth principal tasks.

15. A process according to claim 13, wherein the at least one tool comprises at least one tool from the group comprising:
a scorecard for assessing the relative merits of a plurality of Y variables; and
a scorecard for assessing the relative merits of a plurality of X variables.

16. A method for developing a model and integrating the model into a business intelligence system, comprising:
providing first information regarding a structured process for developing and integrating the model, the first information specifying process operations including:
defining at least one variable X to serve as an input to the model and at least one output variable Y to serve as an output of the model;
assessing whether there is sufficient data of sufficient quality to operate the model in the business intelligence system of the business, and creating a prototype design of the model;
further developing the prototype design of the model to produce a final model design, and validating output results provided by the final model design;
implementing the final model design to produce an implemented model, and developing an interface that enables a user to interact with the implemented model; and
integrating the implemented model and associated interface into the business intelligence system to provide an integrated model, and repetitively monitoring the accuracy of the output results provided by the integrated model;
providing second information regarding at least one tool used in the process operations;
developing the model and integrating the model into the business intelligence system by performing the process operations specified in the first information using the at least one tool specified in the second information.

17. A method according to claim 16, wherein the integrated model predicts a business metric that reflects one aspect of the business's performance.

18. A method according to claim 16, wherein the first information and the second information are stored in a data storage device.

19. A method according to claim 18, wherein the providing of the first information comprises retrieving the first information from the data storage device and presenting the first information to a user via a display device, and wherein the providing of the second information comprises retrieving the second information from the data storage device and presenting the second information to a user via the display device.

20. A method according to claim 19, wherein the display device is communicatively coupled to a computer, and wherein the computer is configured to retrieve the first information and the second information from the data storage device.

21. A method according to claim 16, wherein the second information specifies a worksheet that provides a guideline for performing analysis in connection with at least one step in the process.

22. A method according to claim 16, wherein the at least one tool comprises at least one tool from the group comprising:
a scorecard for assessing the relative merits of a plurality of Y variables; and
a scorecard for assessing the relative merits of a plurality of X variables.

23. A system for assisting a user in developing a model and integrating the model into a business intelligence system, comprising:
a database providing:
(a) first information regarding a structured process for developing and integrating the model, the first information specifying process operations including:
defining at least one variable X to serve as an input to the model and at least one output variable Y to serve as an output of the model;
assessing whether there is sufficient data of sufficient quality to operate the model in the business intelligence system of the business, and creating a prototype design of the model;
further developing the prototype design of the model to produce a final model design, and validating output results provided by the final model design;
implementing the final model design to produce an implemented model, and developing an interface that enables a user to interact with the implemented model; and
integrating the implemented model and associated interface into the business intelligence system to provide an integrated model, and repetitively monitoring the accuracy of output results provided by the integrated model;
(b) second information regarding at least one tool used in the process operations;
an access device coupled to the database for retrieving the first information and the second information; and
an output device coupled to the access device for presenting the first information and the second information to the user.

24. A system according to claim 23, wherein the integrated model predicts a business metric that reflects one aspect of the business's performance.

25. A system according to claim 23, wherein the access device comprises a computer.

26. A system according to claim 23, wherein the database is coupled to the access device via a network.

27. A system according to claim 23, wherein the output device includes a graphical user interface display.

28. A system according to claim 23, wherein the access device is configured to present an interface page on the output device that provides a visual representation of principal tasks in the process.

29. A system according to claim 23, wherein the access device is configured to present an interface page on the output device that provides a visual representation of the at least one tool.

30. A system according to claim 23, wherein the at least one tool comprises at least one tool from the group comprising:
a scorecard for assessing the relative merits of a plurality of Y variables; and
a scorecard for assessing the relative merits of a plurality of X variables
